(19) United States
(12) Patent Application Publication
(10) Pub. No.: US 2023/0298050 A1
(43) Pub. Date: Sep. 21, 2023

(54) VIRTUAL PRICE TAG FOR AUGMENTED REALITY AND VIRTUAL REALITY

(71) Applicant: Inter IKEA Systems B.V., LN Delft (NL)

(72) Inventors: Martin ENTHED, Steninge (SE); Ali Samini, Åstorp (SE)

(73) Assignee: Inter IKEA Systems B.V., LN Delft (NL)

(21) Appl. No.: 18/122,013

(22) Filed: Mar. 15, 2023

Related U.S. Application Data
(63) Continuation-in-part of application No. 17/695,436, filed on Mar. 15, 2022, now abandoned.

(51) Int. Cl. G06Q 30/02; G06Q 30/0601

(52) U.S. Cl. CPC G06Q 30/02; G06Q 30/0643; G06Q 30/0623

(57) ABSTRACT

In general terms, this disclosure is directed to methods and systems for presenting a virtual price tag. One aspect is A method for presenting virtual price tags, the method comprising identifying a product visible in a scene, retrieving price data for the product, identifying visible surfaces of the product from a current view of the scene, determining a predetermined point on one of the visible surfaces based on the current view of the scene, and generating, on a display of a computing device, a virtual price tag attached to an image of the product at the predetermined point, the virtual price tag displaying the price data for the product.

### CROSS-REFERENCE TO RELATED APPLICATION

This application is a continuation-in-part of U.S. patent application Ser. No. 17/695,436, filed on Mar. 15, 2022, the disclosure of which is hereby incorporated by reference in its entirety. To the extent appropriate, a claim of priority is made to the above disclosed application.

### BACKGROUND

Some existing e-commerce applications includes features for viewing products and information about products in augmented reality (AR) or virtual reality (VR). For example, existing e-commerce applications include features for presenting a virtual product to appear to the user in 3D using AR technologies. Such solutions allow a user to view a product digitally in a desired location. Similar solutions exist in VR. For example, a user can navigate a virtual room or store with one or more products. Additionally, some existing solutions display product information using AR or VR.

In some existing AR or VR solutions, information for a product is displayed with buttons or links on a 2D user-interface element. For example, information can be displayed on a 2D panel shown adjacent or on top of a product. In some examples, the information includes product name, price information for the product, user reviews for the product, and promotional information.

### SUMMARY

In general terms, this disclosure is directed to methods and systems for presenting a virtual price tag. In some embodiments, the virtual price tag is presented in augmented reality (AR). In other embodiments, the virtual price tag is presented in virtual reality (VR).

One aspect is a method for presenting virtual price tags, the method comprising identifying a product visible in a scene, retrieving price data for the product, identifying visible surfaces of the product from a current view of the scene, determining a predetermined point on one of the visible surfaces based on the current view of the scene, and generating, on a display of a computing device, a virtual price tag attached to an image of the product at the predetermined point, the virtual price tag displaying the price data for the product.

Another aspect is an augmented reality device comprising a camera, a processor, and a memory storing instructions which, when executed by the processor cause the augmented reality device to identify a product in a physical scene, retrieve price data for the product, identify visible surfaces on the product from a current view of the physical scene, determine a predetermined point on one of the visible surfaces based on the current view of the physical scene, and generate, on a display of the augmented reality device, a virtual price tag attached to an image of the product at the predetermined point, wherein the virtual price tag displays the price data for the product.

Yet another aspect is a virtual reality device comprising a processor and a memory storing instructions which, when executed by the processor cause the virtual reality device to identify at least one product visible in a virtual scene and for each product of the at least one product retrieve price data for the product, identify visible surfaces of the product from a current view of the virtual scene, determine a predetermined point on one of the visible surfaces based on the current view of the virtual scene, and generate, on a display of the virtual reality device, a virtual price tag attached to an image of the product at the predetermined point, wherein the virtual price tag displays the price data for the product.

### BRIEF DESCRIPTION OF THE DRAWINGS

FIG. 1 illustrates an example e-commerce system.

FIG. 2 illustrates an example user computing device.

FIG. 3 illustrates an example e-commerce server.

FIG. 4 illustrates an example method for presenting a virtual price tag.

FIG. 5 illustrates an example method for determining an optimal location to position the virtual price tag.

FIG. 6 illustrates an example method for determining visible locations to place a virtual price tag.

FIG. 7 illustrates and example method for displaying a virtual price tag.

FIG. 8 illustrates an example augmented reality environment for displaying a virtual price tag.

FIG. 9 illustrates an example augmented reality environment for displaying a virtual price tag.

FIG. 10 illustrates an example virtual reality environment for displaying a virtual price tag.

FIG. 11 illustrates example views displayed by the virtual price tag viewer.

FIG. 12 illustrates an example user-interface of the virtual price tag viewer.

FIG. 13 illustrates an example virtual price tag.

FIG. 14 illustrates an example user-interface of the virtual price tag viewer.

FIG. 15 illustrates a block diagram of an example price tag viewer architecture.

FIG. 16 illustrates a block diagram of an example dynamic variables engine.

FIG. 17 illustrates a block diagram of an example scene checker.

FIG. 18 illustrates a block diagram of an example preference engine.

FIG. 19 illustrates a block diagram of an example price tag applicator.

FIG. 20 illustrates an example display of a virtual price tag application including a product comprising an assembly of sub-products.

FIG. 21 illustrates an example display of a virtual price tag application including a product comprising an assembly of sub-products.

FIG. 22 illustrates an example method for selecting a virtual price tag for a checkout process.

FIG. 23 illustrates an example method for presenting two or more virtual price tags in VR and/or AR.

FIG. 24 illustrates an example virtual reality interface with multiple virtual price tags selected.

FIG. 25A illustrates an example virtual reality interface with multiple virtual price tags selected.

FIG. 25B illustrates an example virtual reality interface with multiple virtual price tags selected.

FIG. 26 illustrates an example method for storing one or more virtual price tags in a user's inventory.

FIG. 27 illustrates an example method for transporting a user to a virtual location associated with the selection of a virtual price tag.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general terms, this disclosure is directed to methods and systems for presenting a virtual price tag using augmented reality or virtual reality technologies. In some embodiments, the virtual price tag is displayed on a physical item in augmented reality. In some embodiments, the virtual price tag is displayed on a virtual item in augmented reality. In some embodiments, the virtual price tag is displayed on a virtual item in virtual reality. In some embodiments, the virtual price tag is shown on virtual products within a furnishing layout planner. Some embodiments include combinations of the above.

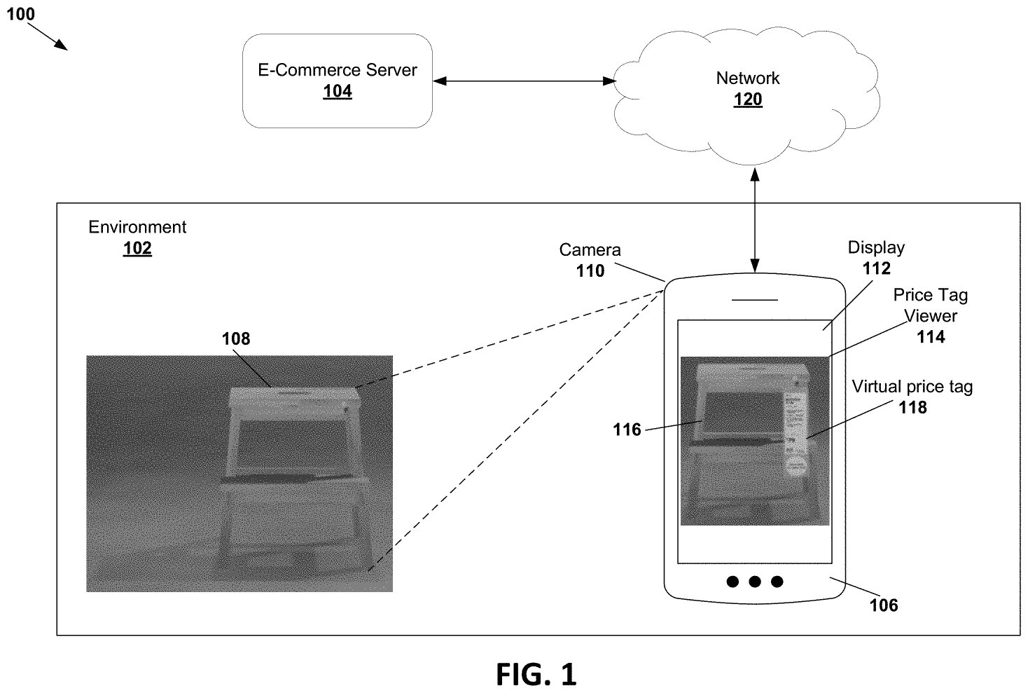

FIG. 1 illustrates an example e-commerce system 100. The example e-commerce system 100 includes an environment 102 with a user computing device 106 and a product 108. The user computing device 106 is in digital communication with an e-commerce server 104 via a network 120.

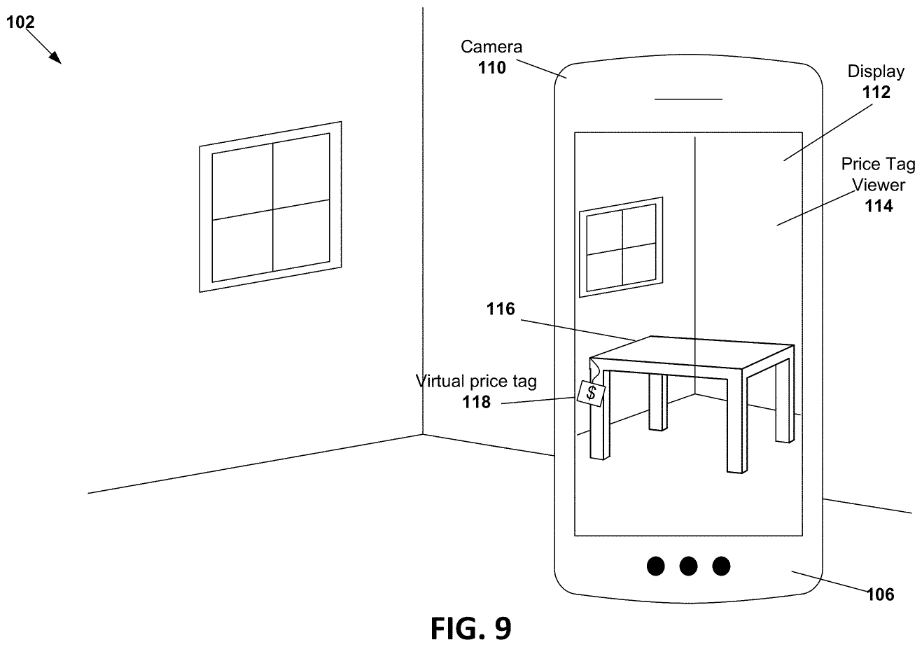

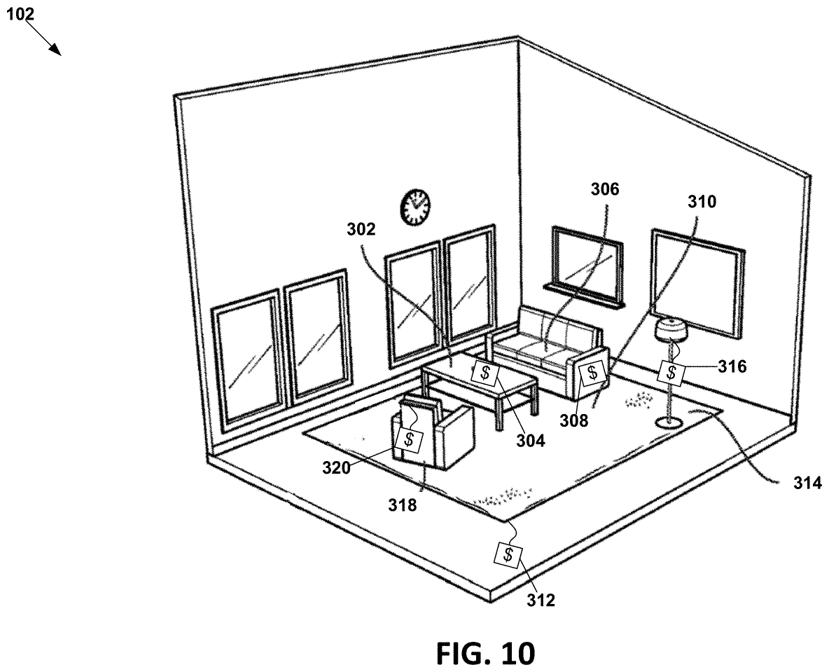

The environment 102 can include either an augmented reality scene or a virtual reality scene. The augmented reality scene can include any physical space. For example, an augmented reality scene could include a room in a house, a store, warehouse, backyard, event space, convention staged model home/apartment etc. Examples of augmented reality environments are illustrated and described in reference to FIGS. 9 and 10. In other examples, the environment 102 is a virtual reality scene. Examples, of virtual reality scenes include a virtual reality store or virtual reality home. An example virtual reality environment is illustrated and described in reference to FIG. 10. In some examples, the environment 102 is a scene presented with a furnishing planner.

In some embodiments, the environment 102 includes a product 108. In many embodiments, illustrated and described herein, the product 108 is a furnishing. Example furnishings includes furniture items (for example, couches, tables, bookshelves, dressers, storage units, beds, chairs, etc.) and other home items (for example, clocks, kitchen appliances, artwork, lighting, etc.). The product 108 can also include electronics (e.g., TV), groceries, vehicles, and sporting equipment. Other products can also be used and fall within this disclosure. In some embodiments, the environment 102 does not include a product 108 and a virtual product is displayed in either AR or VR.

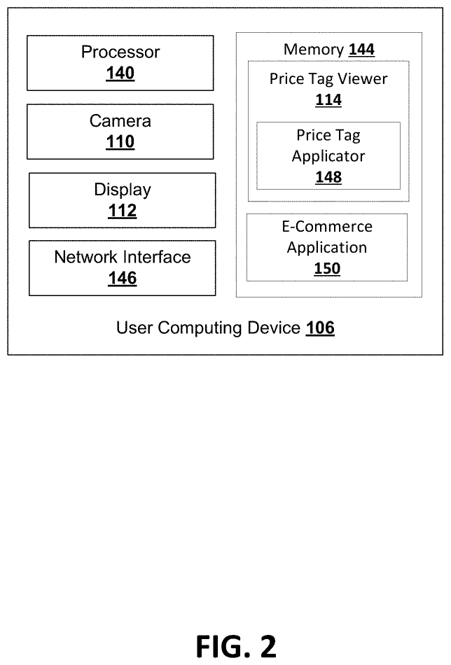

In some embodiments, the user computing device 106 includes a camera 110 and a display 112. The user computing device operates a price tag viewer 114 which displays a product image 116 with a virtual price tag 118 attached in AR or VR. In some embodiments, the user computing device 106 is a mobile computing device such as a smart phone or tablet. In some examples, the user computing device 106 is a device optimized for augmented reality applications, such as smart glasses. In some examples, the user computing device 106 is a virtual reality device, such as a VR headset with hand controls. In some embodiments, the user computing device 106 is a laptop or desktop. An example user computing device 106 is illustrated and described in reference to FIG. 2.

In some embodiments, the user computing device includes a camera 110. In augmented reality systems the camera 110 captures images of the environment 102. These images are overlayed with augmented reality elements. In some embodiments, the camera 110 captures an image or stream of images of the product 108, the image or stream of images are used to identify the product and/or as a background to overlay a virtual price tag.

The user computing device 106 includes a display 112. The display can be any electronic display which can present the price tag viewer 114. In some examples, the display 112 is a screen, such as a television or monitor. In other examples, the display 112 is a touch screen, for example, on a smart phone or tablet. In other examples, the display is presented on an augmented reality device, such as smart glasses. Other examples include VR displays (VR headset), projected display, or a holographic displays.

The user computing device 106 operates a price tag viewer 114 which displays a product image 116 with a virtual price tag 118. In some embodiments, the price tag viewer 114 is an augmented reality application. In other embodiments, the price tag viewer 114 is a virtual reality application. Other examples include a furnishing planning application. In some embodiments, the furnishing planning application is used to generate the virtual reality scene.

In some embodiments, the product image 116 is an image of a physical product. For example, the product 108. In other examples, the product image 116 is a virtual product which is displayed in 3D in either augmented reality or virtual reality. In some of these examples, a user selects a product from a catalog of products and the product image 116 is a 3D model of the product which can be generated in AR and/or VR. Example 3D model file formats which could be used in the AR or VR embodiments include gITF, glb, and glb(draco) and USDZ. In some embodiments, the e-commerce server 104 stores the 3D models and sends the 3D models in the correct format to render on the user computing device 106. In other embodiments, the user computing device 106 converts the 3D model file into the correct format.

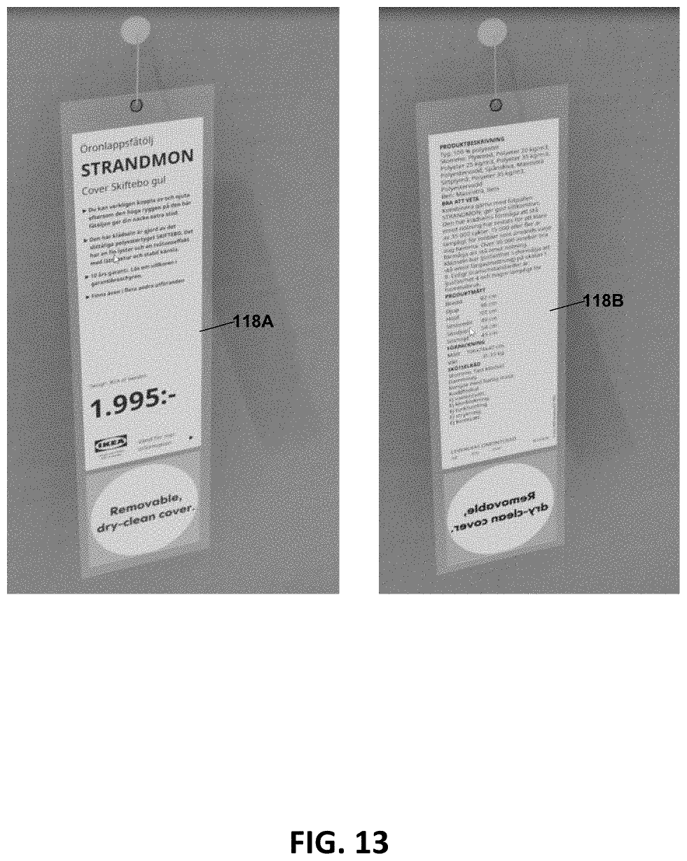

The virtual price tag 118 displays information about the product 108. In some embodiments, the virtual price tag 118 is a 3D model of a price tag. The virtual price tag 118 is presented over the product image 116, for example, in either AR or VR. The virtual price tag is generated to look realistic and is placed where a physical price tag would typically be placed on the physical product. For example, the virtual price tag 118 can be displayed in the digitally augmented world in the way customers are used to locating price information in the physical world. In some examples, the virtual price tag is displayed in augmented reality attached to the product in a realistic way and which does not block the view in an augmented environment. An example, of the virtual price tag 118 is illustrated in FIG. 13.

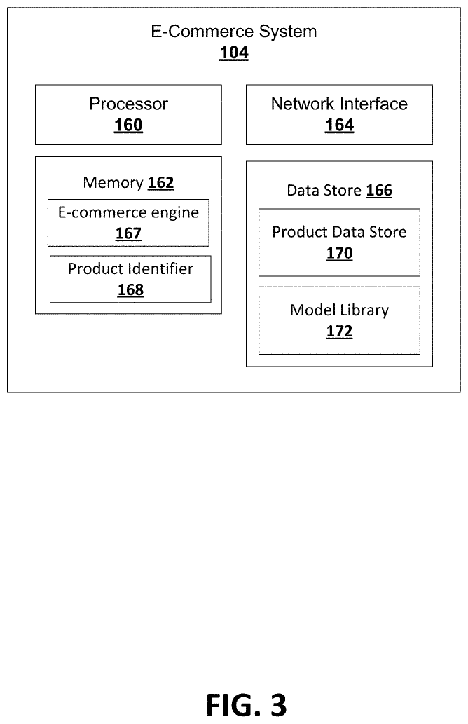

In some embodiments, the user computing device 106 is in digital communication with the e-commerce server 104 via the network 120. The e-commerce server 104 operates to perform e-commerce operations. For example, the e-commerce server 104 may store product information, customer information, e-commerce web services, customer account processes, purchase processes, delivery processes, inventory management, etc. In many embodiments, the e-commerce server 104 operates with the user computing device 106 to perform the method described herein. An example e-commerce server 104 is illustrated and described in reference to FIG. 3.

The network 120 connects the user computing device 106 to the e-commerce server 104. In some examples, the network 120 is a public network, such as the Internet. In example embodiments, the network 120 may connect with media playback devices through a Wi-Fi® network or a cellular network.

FIG. 2 illustrates an example user computing device 106. The user computing device 106 is an example of the user computing device 106 illustrated in FIG. 1. The user computing device includes a processor 140 operatively connected to a memory 144, camera 110, display 112, and network interface 146.

The processor 140 comprises one or more central processing units (CPU). In other embodiments, the processor 140 includes one or more digital signal processors, field-programmable gate arrays, or other electronic circuits. In some embodiments, the processors include one or more processors (e.g., virtual, or physical processors) executing instructions to perform algorithms to achieve a desired results. Additionally, in some embodiments, additional input/output devices are operatively connected with the processor 140. For example, VR hand controls, mouse, keyboard, microphone, speaker etc.

The memory 144 is operatively connected to the processor 140. The memory 144 typically includes at least some form of computer-readable media. Computer-readable media can include computer-readable storage media and computer-readable communication media.

Computer-readable storage media includes volatile and nonvolatile, removable and non-removable media implemented in any device configured to store information such as computer-readable instructions, data structures, program modules, or other data. Computer-readable storage media includes, but is not limited to, random access memory, read-only memory, flash memory, and other memory technology, compact disc read-only memory, BLUERAY® discs, digital versatile discs or other optical storage, magnetic cassettes, magnetic tape, magnetic disk storage or other magnetic storage devices, or any other medium that can be used to store the desired information and that can be accessed by the user computing device 106. In some embodiments, computer-readable storage media is non-transitory computer-readable storage media.

Computer-readable communication media typically embodiments computer-readable instructions, data structures, program modules, or other data in a modulated data signal such as a carrier wave or other transport mechanism and includes any information delivery media. The term “modulated data signal” refers to a signal that has one or more of its characteristics set or changed such a manner as to encode information in the signal. By way of example, computer readable communication media includes wired media such as a wired network or directed wired connection, and wireless media such as acoustic, radio frequency, infrared, and other wireless media. Combinations of any of the above are also included within the scope of computer-readable media.

A number of program modules can be stored in the memory 144 or in a secondary storage device, including an operating system, one or more application programs, and other program modules, and program data. In some embodiments, the memory stores instructions for a price tag viewer 114, a price tag applicator 148, and/or an e-commerce application 150. In some embodiments, the memory 144 stores instructions to perform some or all of the methods disclosed herein.

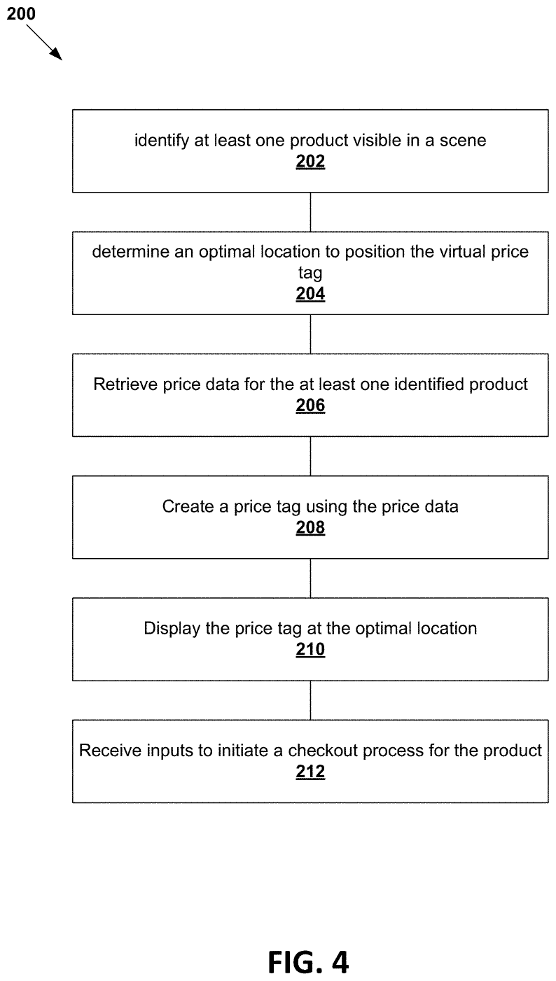

The price tag viewer 114 operates to generate a virtual price tag. The price tag viewer 114 is another example of the price tag view shown in FIG. 1. The price tag viewer 114 generates a user interface on the display 112 to show the virtual price tag attached to an item in AR or VR. In typical embodiments, the virtual price tag is a 3D model of price tag which include price data of a product. The price data can include other information about the product such as name, description, and customizations. The virtual price tag is displayed in AR or VR to match a physical price tag on a physical product. An example of a virtual price tag is illustrated and escribed in FIG. 13. In some embodiments the price tag viewer 114 operates the methods 200, 204, 234, and 210 illustrated and described in reference to FIGS. 4, 5, 6, and 7 respectively.

The price tag viewer 114 includes a price tag applicator 148. The price tag applicator 148 operates to determine an optimal location to place the virtual price tag. In some embodiments, the optimal location is a location where a price tag would be placed on a physical item. In some embodiments, the price tag applicator 148 receives a list of predetermined points on the product to place the virtual price tag and select the optimal predetermined point based on the current view of the product. In some embodiments, the optimal location is further based on conditions in the scene. Conditions can include lighting conditions and occluding objects. In some examples, the preterminal points may be ranked based on likelihood a price tag would be placed at each point on a physical product. The highest ranked visible predetermined point is then selected. In some embodiments, the price tag applicator 148 determines a location to place the virtual price tag based on a policy. For example, the price tag applicator 148 may select a location on the top left corner of the largest visible surface. Another policy could include placing the virtual price tag on the surface closest to the front, or the front surface when visible. In some embodiments, a machine learning model is trained to select an optimal point. For example, a machine learning model can be trained on a plurality of training images which include products with price tags at optimal locations. In some of these embodiments, the model is trained to work on a variety of products. In others a model can be trained on a specific product. Combinations of the above can also be used to determine the location to place the virtual price tag.

In some embodiments, a product includes a single predetermined point where the virtual price tag is always placed. In these embodiments, the virtual price tag may not always be visible at the current angle or may be in a shadow. Typically, the predetermined point will be the location where a price tag is typically placed on the physical product. For example, on the side of a cereal box.

The e-commerce application 150 operates to perform e-commerce operations. For example, the e-commerce application 150 can include a catalog of products which a user can select one or more products from. In some embodiments, when a user selects a product, a user can further select to view the selected product in AR or VR. Once selected the product is shown with a virtual price tag at the determined location. The e-commerce application 150 can include other features, for example, features for a user account, payment processing features collecting payment and delivery details, a shopping list feature for generating a shopping list, etc.

In some embodiments, the user computing device includes a camera 110. The camera 110 is used to capture an image of a scene and, in some embodiments, one or more products. For example, the camera can be used to capture the background of a physical environment where a virtual product with a virtual price tag are displayed. Or the camera may be used to capture an image or stream of images of a product. The images are used to identify a product and then place a virtual price tag in AR. The camera can be any type of camera typically used on mobile computing devices, or augmented reality computing devices. In VR examples, the user computing device 106 may not include a camera or may not utilize the camera. In some examples, the camera is used to capture a machine readable code (e.g., a QR code) which include an identifier for a product. In some embodiments, the machine readable code includes an encoded virtual scene which is generated by the user computing device when scanned, wherein the virtual scene includes one or more products each with a virtual price tag.

Other sensors can also be used to capture 3D details of a physical environment. For example, a LIDAR sensor, ultrasonic distance sensor, or using sound generated by a speaker and analyzing the echo received at a microphone. In other embodiments, images from two or more cameras are used to calculate 3D features in the physical environment.

The display 112 can be any electronic display which is able to present the price tag viewer 114. In some examples, the display 112 is a screen, such as a television or monitor. In other examples, the display 112 is a touch screen, for example, on a smart phone or tablet. In other examples, the display is presented on an augmented reality device, such as smart glasses. Other examples include VR displays (VR headset), projected display, or a holographic displays.

The network interface 146 operates to enable the user computing device 106 to communicate with one or more computing devices over one or more networks, such as the network 120 shown in FIG. 1. For example, the user computing device 106 is configured to communicate with the e-commerce server 104 to perform many of the methods disclosed herein. The network interface 146 can be an interface of various types which connects the user computing device 106 to a network. Examples included wired and wireless interfaces.

FIG. 3 illustrates an example e-commerce server 104. The e-commerce server 104 is another example of the e-commerce server 104 shown in FIG. 1. The e-commerce server 104 includes a processor 160 operatively connected to a memory 162, a network interface 164, and a data store.

The e-commerce server 104 includes a processor 160, a memory 162, and a network interface 164. Examples of processors, memories, and network interfaces are described herein. For example, the processor 140, the memory 144, and the network interface 146 illustrated and described in reference to FIG. 2.

A number of program modules can be stored in the memory 162 or in a secondary storage device, including an operating system, one or more application programs, and other program modules, and program data. In the example shown, the memory 162 stores instructions for an e-commerce engine 167, a product identifier 168, and/or other e-commerce web services.

The e-commerce engine 167 operates to provide e-commerce web services. For example, e-commerce user interfaces, e-commerce check out processes, customer account services, etc. In some embodiments, the e-commerce engine 167 serves web pages for various products of a specific retailer. In other embodiments, the e-commerce engine 167 is a platform for different users and vendors to sell products.

In some embodiments, the e-commerce server 104 operates the product identifier 168. The product identifier operates to identify a product. In some examples, the product identifier 168 receives an image or stream of images uploaded from the user computing device 106. The product identifier 168 processes the image to identify a product in the image. Examples of processing the image includes computer vision algorithms and/or machine learning techniques. In some embodiments, the product identifier 168 receives a product ID or code. In alternative embodiments, the product identifier 168 operates on the user computing device 106.

The data store 166 stores information for the e-commerce server 104. In some embodiments, the data store 166 stores a product data store 170 and a model library 172. In some embodiment the data store 166 is located at one or more specialized servers with specialized storage services or in a cloud computing system.

The product data store 170 stores information for products. The product data store 170 can store a product ID, product name and description, customization options, price information, inventory information, dimensions, weight, delivery options, etc. The product data store can operate with the e-commerce engine 167 and/or the product identifier 168. For example, the product data store 170 can be used to provide product information to the e-commerce engine 167 for e-commerce services. In another example. the product data store 170 operates with the product identifier 168 to provide information to identify a product in an image and/or to provide product data for the identified images.

The model library 172 stores 3D models of one or more virtual price tags. In some embodiments, the model library further store 3D models of different products. In some embodiments, the models are in an AR and/or VR format. Example 3D model formats include: gITF, glb, and glb(draco) and USDZ. In some embodiments, the e-commerce server 104 stores the 3D models and sends the 3D models in the correct format to render on the user computing device 106 (e.g., in response to receiving compatible format information from the user computing device 106). In other embodiments, the format store at the model library 172 is a generic format and the user computing device 106 converts the 3D model file into the correct format.

Although FIG. 3 shows a single e-commerce sever 104, some embodiments include multiple servers or other computing systems. In these embodiments, each of the multiple servers can be identical or similar and may provide similar functionality to provide greater capacity, redundancy, and services from multiple geographic locations. Additionally or alternatively, some of the multiple servers may be optimized to perform specialized functions for specific services.

The user computing device 106 illustrated and described in FIG. 2 and the e-commerce server 104 illustrated and described in FIG. 3 are examples of programmable electronics, which may include one or more such computing devices and when multiple computing devices are included, such computing devices can be coupled together with a suitable data communication network so as to collectively perform the various functions, methods, or operations disclosed herein.

FIG. 4 illustrates an example method 200 for presenting a virtual price tag. In some embodiments, the method 200 is performed on the user computing device 106 as illustrated and described in either FIG. 1 or FIG. 2. The method 200 includes the operations 202, 204, 206, 208, 210, and 212.

The operation 202 identifies at least one product visible in a scene. In some embodiments, a camera on a user computing device captures an image of a product and an algorithm is used to identify the product. For example, a computer vision or machine learning algorithm is used to identify the product. In other examples, a user may enter a product ID or scan a product ID (e.g., with a machine readable code). In further examples, a user can select the product from a catalog of products. For example, a user can use a furnishing planning application to generate a virtual room by selecting products which are associated with product IDs.

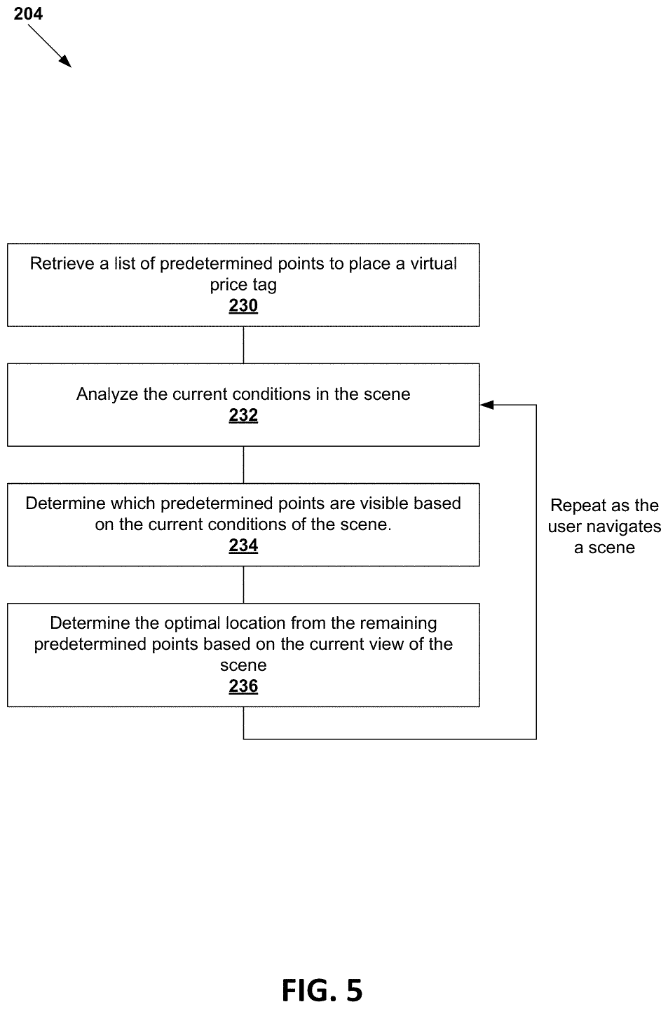

The operation 204 determines an optimal location to position the virtual price tag. An example method 204 for the operation 204 is illustrated and described in reference to FIG. 5. In some embodiments, the optimal location to position the virtual price tag is based on the current view of the product. For example, the optimal location can be based on the view (angle), occluding objects, rotation of product, size of product, placement of product. In some embodiments these factors are used to determine which surfaces are visible from the current view. The virtual price tag is then attached to one of these visible surfaces.

In some embodiments, the user computing device receives a list of predetermined points from the e-commerce server. The predetermine points correlate with locations where a price tag would be placed on a physical product. The price tag applicator determines which surfaces are visible under the current conditions. Based on these identified surfaces the algorithm looks at which predetermined points are visible and selects an optimal predetermined point. In some embodiments, the optimal predetermined point is based on the likelihood a physical product in a store would be placed at each predetermined point.

In some embodiments, a price tag application policy is applied to select the optimal location for the virtual price tag. For example, one policy may select the top left location on the largest visible surface. Other polices can be based on the specific product. For example, a policy may prioritize placing the virtual price tag on the front surface of a dresser whenever the front is visible.

In some embodiments, a model trained to determine an optimal location to place the virtual price tag. For example, a machine learning model can be trained with images of products in showrooms and stores. Based on these training images the machine learning model can map where price tags are typically placed to determine where to place the virtual price tag. In some embodiments, a general model is trained on various product and, in other examples, a model is trained on a specific product or a specific type of product.

In alternative embodiments, the optimal location is a single predetermined location and is only visible when the user is at certain views to the product. For example, the price tag may be placed on the front of a dresser and is not visible to a user viewing the dresser from the back.

Other embodiments select an optimal point using any combination of predetermined points, policies, and machine learning models.

The operation 206 retrieves price data for the at least one identified product. The price data includes price information for the product. The price data may also include additional product information, such as product customization, financing options, promotional information, product description, product shipment or pick up information, inventory information, etc. In some embodiments the operation 206 is done concurrently with the operation 202, (e.g., the price data is sent in response to the e-commerce server identifying the product). In some embodiments, the price data and product description is based on the geographic location of the user. For example, the currency and language of the virtual price data is based on currency and common language at the geographic location of the user computing device.

The operation 208 creates a virtual price tag with the price data. An example of a virtual price tag is illustrated and described in reference to FIG. 13. The virtual price tag is typical a 3D virtual model which is overlayed in AR or VR. The virtual price tag may include features which a user would expect on a physical price tag for the product. In some embodiments, the price tag is attached to the product with a virtual string. In some embodiments, a user can select the virtual price tag and an enlarged price tag is displayed to the user. In some of these embodiments, the price tag may appear in a user's hand using AR or VR. In some embodiments, the virtual price tag is displayed with the lighting conditions in the scene (e.g., with a shadow across the price tag). In some embodiments, the price tag is affixed digitally to the product as it would be affixed physically to the product. For example, hanging from a string, spring sticking through fabric, string going through a product (like a cushion), glued on to a mirror or bookcase, painted on a car, etc.

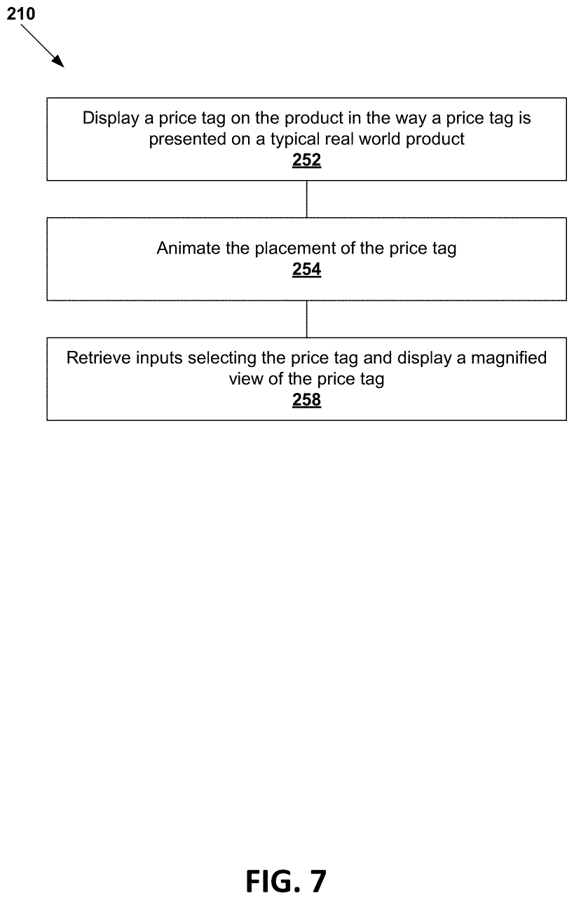

The operation 210 displays the price tag at the optimal location, as determined by the operation 204. In some embodiments, the virtual price tag is placed with an animation to bring attention to the virtual price tag. For example, the price tag may swing slight on a string or bounce. In some embodiments, the animation is made to draw the user's attention to the virtual price tag. An example method 210 of the operation 210 is illustrated and described in reference to FIG. 7.

In many embodiments, the operations 204 and 210 are repeated as the view of the product changes. For example, when applied in an AR environment as the user moves or in the VR environment when the user changes the view of the product. The operations are repeated such that the price tag is moved to an optimal location at each of the different views.

The operation 212 receives inputs to initiate a checkout process for the product. In some examples, the operation 212 includes placing the product in an online shopping cart and receiving details for processing the payment for an order and delivering the order. In some embodiments, the operations 212 includes generating a shopping list for a user to bring to a physical store.

FIG. 5 illustrates an example method 204 for determining an optimal location to position the virtual price tag. In some embodiments, the method 204 is performed on the user computing device 106, such as the user computing device shown in FIG. 1 or 2. The method 204 is an example of the operation 204 illustrated and described in reference to FIG. 4. The method 204 includes the operation 230, 232, 234, and 236.

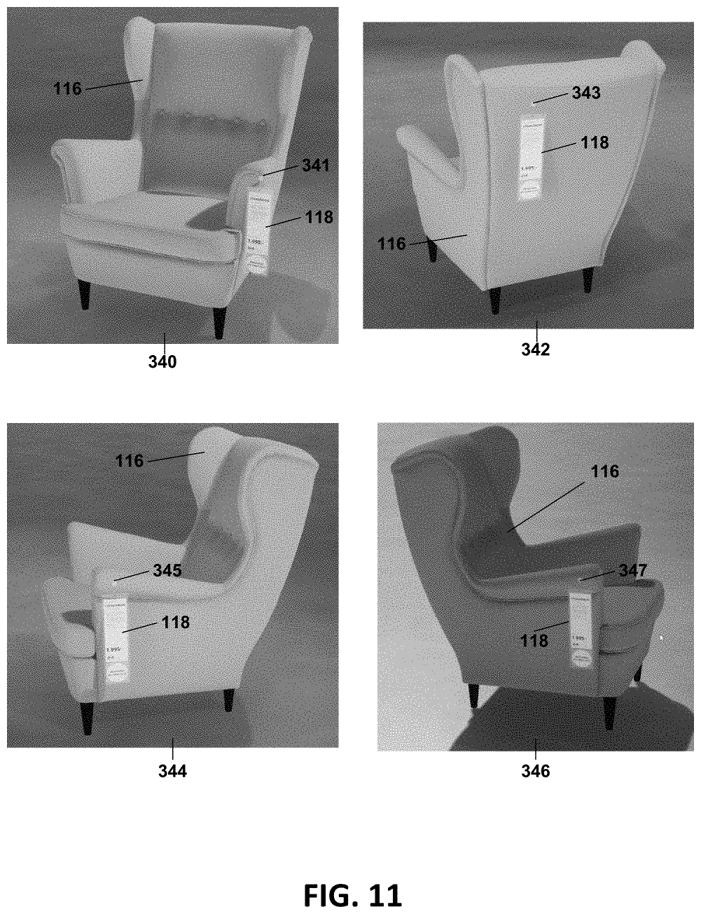

The operation 230 retrieves a list of predetermined points to place a virtual price tag. In some embodiments, the list of predetermined points includes all possible points where a price tag could be attached. In other examples, a single predetermined point is placed on one or more surfaces of the product. In some embodiments, a user can adjust the predetermined points. An example of predetermined points at different view of a product are shown in FIG. 11.

The operation 232 analyzes the current conditions in the scene. Conditions of the scene include local conditions which could interact with the price tag such as wind or other objects. Examples of conditions includes the view (angle), occluding objects, rotation of product, size of product, placement of product, location of the user, lighting (e.g., a shadow on a product), etc.

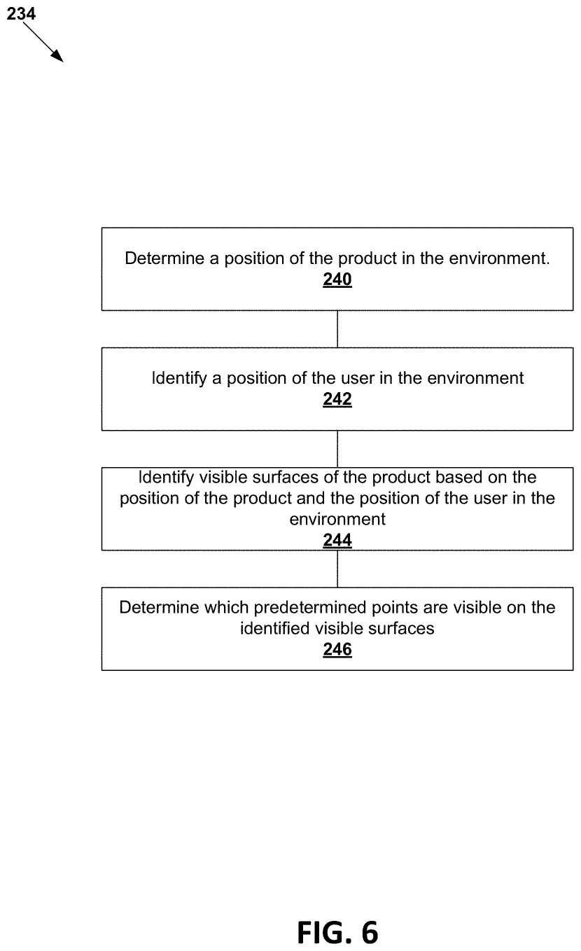

The operation 234 determines which predetermined points are visible based on the current conditions of the scene. In some examples, the visible predetermined points are based on the location of the product relative to the user (or the view of the user in VR), occulting objects, lighting, etc. An example method 234 for the operation 234 is illustrated and described in reference to FIG. 6. In some embodiments, specific predetermined points are excluded based on being impractical to place the virtual price tag.

The operation 236 determines the optimal location from the remaining predetermined points based on the current view of the scene. In some embodiments, the optimal location is based on a policy (e.g., the predetermined point on the largest visible surface or predetermined point on the front of the product, or on the side with better lighting). In other embodiments, each point is scored based on the conditions of the scene. In further embodiments a machine learning model is used to select the optimal predetermined point.

In some embodiments, the operations 232, 234, and 236 repeat as the view of the product changes. For example, in an AR system as the user computing device moves, or in a VR system as the user provides inputs modifying the view. The placement of the price tag is updated to an optimal location which can change as the view changes. An example of different views of a product with different locations for the virtual price tag is illustrated in the views 340. 342, 344, and 346 illustrated and described in reference to FIG. 11.

FIG. 6 illustrates an example method 234 for determining visible locations to place a virtual price tag. The method 234 is an example of the operation 234 illustrated and described in FIG. 5. In some embodiments, the method 234 is performed on the user computing device 106. The method 234 includes the operations 240, 242, 244, and 246.

The operation 240 determines a position of the product in the environment. In some embodiments, sensors on the user computing device are used to determine the 3D location of the product relative to the user. For example, multiple cameras can be used to determine the 3D location, a LIDAR sensor, or by generating a sound with a speaker and recorded the echo with a microphone. In virtual reality embodiments, the VR system is used to determine 3D location of the product.

The operation 242 identifies a position of the user in the environment. In augmented reality embodiments, the location is determined as the location of the user computing device. In virtual reality embodiments, the virtual reality system is used to determine the current location which is used to generate the 3D view of the virtual reality scene.

The operation 244 identifies visible surfaces of the product based on the position of the product and the position of the user in the environment. After determining the position of the product at, the operation 240, and the position of the user at the operation 242, the operation 244 identifies which surfaces are visible to the user based on these positions. Additionally, other condition of the scene (lighting, occluding objects, etc.) are used to determine what surfaces are visible.

The operation 246 determines which predetermined points are visible on the identified visible surfaces. The points which are not on the identified visible surfaces are eliminated. Next, the conditions of the scene are analyzed to determine which of the remaining predetermine points are visible. For example, a point may be on a surface which is partially visible but the predetermined point is not visible (or somewhat obstructed) based on the angle, an occluding object, shadow, etc.

FIG. 7 illustrates and example method 210 for displaying a virtual price tag. The method 210 is an example of the operation 210 illustrated and described in FIG. 4. The method 210 includes the operations 252, 254, and 256.

The operation 252 displays a price tag on the product in the way a price tag is presented on a typical real world product. For example, the virtual price tag is attached to a surface digitally in way it would be attached to a physically.

The operation 254 animates the placement of the price tag. In some examples, the virtual price tag may swing or bounce. In other examples, the virtual price tag may flash or shake. Any animation which is brings the users attention to the virtual price tag can be used.

The operation 256 retrieves inputs selecting the price tag and displays a magnified view of the price tag. In some examples, a user can select the virtual price tag and the price tag is magnified to the user. In some of these examples the virtual price tag is shown digitally to be in the user's hand. In some embodiments a user can select multiple price tags and then display each price tag adjacent to each other. Other inputs can be received to move the price tag. For example, a user can select the price tag to flip the price tag to the opposite side which can include additional information about the product. In some embodiments, a user can select to remove the magnification of the virtual price tag and an animation is displayed of the price tag being snapped back to the product by the virtual string.

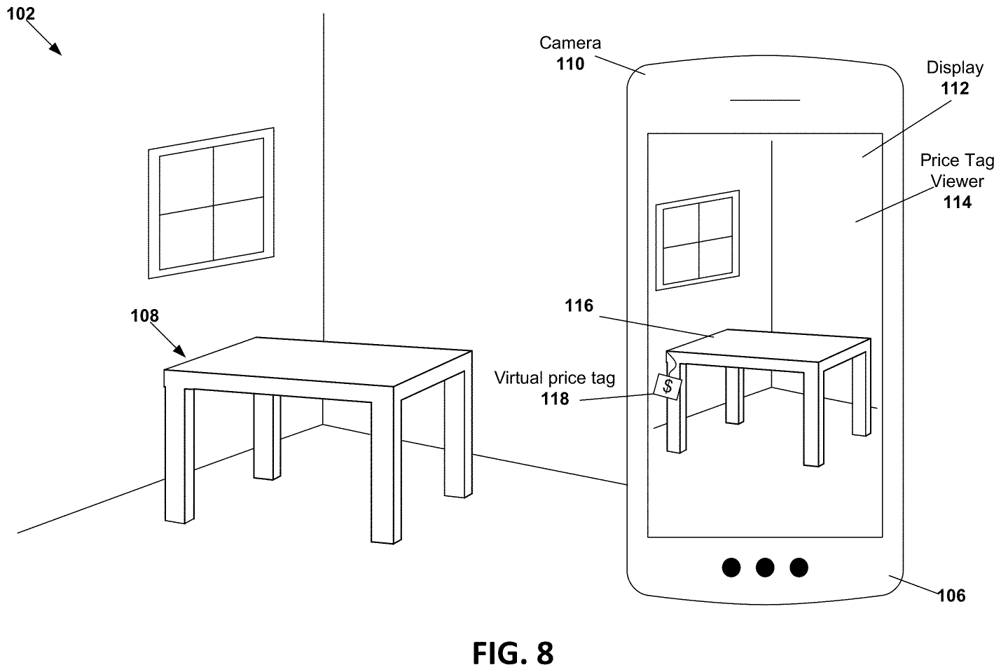

FIG. 8 illustrates an example augmented reality environment 102 for displaying a virtual price tag. The environment 102 includes a physical product 108 and a user computing device 106. In this example, the user computing device 106 captures an image or stream of images of the environment 102 including the physical product 108. The product 108 is identified using the image or stream of images. In some embodiments, the image or stream of images are uploaded to an e-commerce server, which includes image processing capabilities to identify the product 108. In other embodiments, the product is identified at the user computing device 106. Once the product is identified, the price data is retrieved and the price tag viewer 114 generates an augmented reality scene on the display 112. The augmented reality scene includes the virtual price tag 118 affixed to the product image 116.

FIG. 9 illustrates an example augmented reality environment 102 for displaying a virtual price tag. The environment 102 does not include a physical product. In this embodiment, a user selects a product (e.g., from a catalog of products) to display the product image 116 in augmented reality. The camera 110 captures the environment 102 which is used to generate the background on the price tag viewer 114. The price tag viewer 114 generates, on the display 112, the product image 116 with the virtual price tag 118 affixed, both in augmented reality.

FIG. 10 illustrates an example virtual reality environment 102 for displaying a virtual price tag. The virtual reality environment includes a plurality of products 302, 306, 310, 314, and 318 are shown each with a virtual price tags 304, 308, 312, 316 and 320 affixed respectively. In some embodiments, a user can navigate the environment 102 the price tags are adjusted to an optimal location based on the view. In some embodiments the furnishings in the virtual environment 102 are selected and arranged s part of a furnishing planning application.

FIG. 11 illustrates example displays of the virtual price tag viewer. The view 340 show a product image 116 with a virtual price tag 118 affixed at the predetermined point 341. The view 342 shows the product image 116 at different angle with the virtual price tag 118 affixed to the predetermined point 343. The view 344 shows the product image 116 at a third angle with the virtual price tag 118 affixed at the predetermined point 345. The view 346 is at a fourth angle and shows the virtual price tag 118 affixed to the furnishing image at the predetermined point 347. In some embodiments, as a user navigates around the product the virtual price tag is updated to the corresponding predetermined points. In some examples, users can provide inputs to adjust the predetermined points. For example, an admin user can update the predetermined points to place the price tag at an improved location. In other examples, a customer user can update the predetermined points based on their preferences.

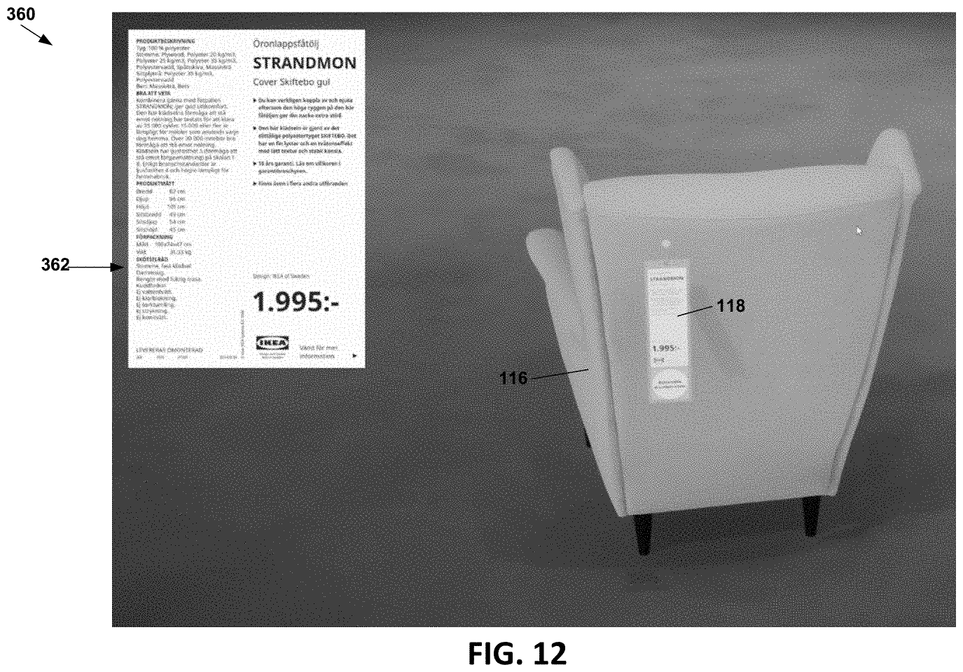

FIG. 12 illustrates an example user-interface 360 of the virtual price tag viewer. The user-interface 360 displays the virtual price tag 118 affixed to the product image 116 and a magnified price tag 362. In some embodiments, the user provides inputs to the user-interface 360 which cause the user-interface to present the magnified price tag 362. For example, a user can click the price tag or provide another gesture to magnify the price tag (e.g., reverse pinch). In other examples, the magnified price tag 362 is digitally shown in the user's hand using AR or VR.

FIG. 13 illustrates an example virtual price tag. The example shown include a front side of the virtual price tag 118A and a back side of the virtual price tag 118B. In some embodiments, a user select the price tag to rotate the price tag. In alternative examples, other gestures flip the price tag. For example, a hand tracker could follow a user's hand to flip the virtual price tag. In the embodiment shown, the front side of the virtual price tag 118A displays the product name, price, and product information and the back side of the virtual price tag 118B shows additional information about the product.

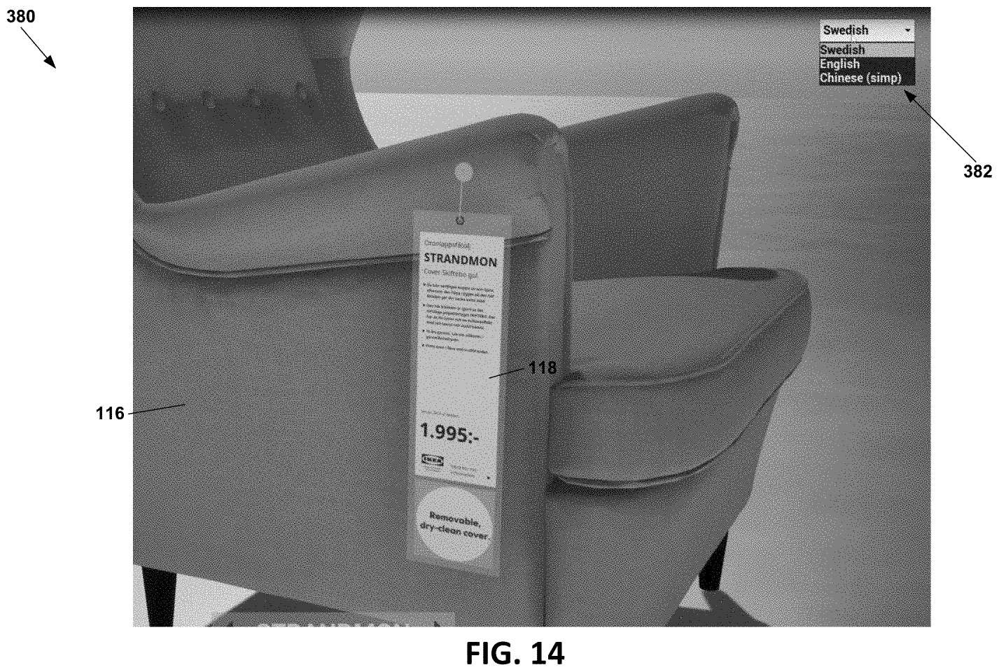

FIG. 14 illustrates an example user-interface 380 of the virtual price tag viewer. The user-interface 380 includes the product image 116, the virtual price tag 118 and a language selector 382. The language selector 382 is a user-interface element which allows the user to modify the language displayed on the virtual price tag. For example, when a user changes the selected language the data on the price tag is updated to the selected language. Other price tag settings can be modified with similar user-interface elements. For example, the currency displayed on the price tag or customizations of the product.

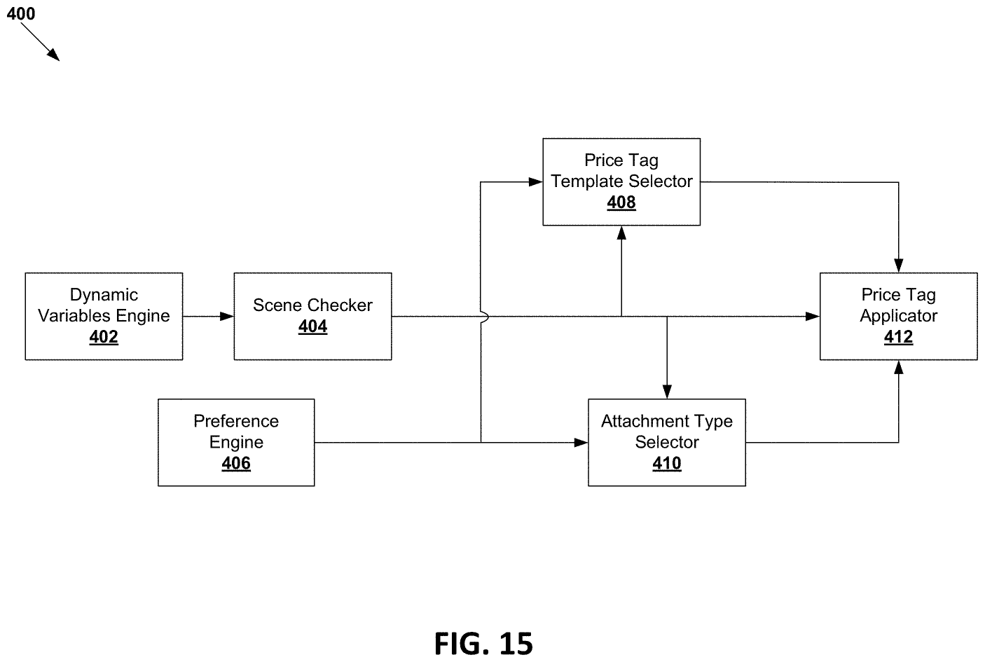

FIGS. 15-19 illustrate block diagrams of an example price tag viewer 400 architecture. In some embodiments, the architecture is implemented as part of the e-commerce system 100 illustrated and described in reference to FIG. 1. In some of these embodiments, the architecture is implemented as a set of instructions which are executed by at least one processor in the user computing device 106. In some embodiments, the user computing device 106 is in digital communication with the e-commerce server 104 which executes some of the operations or steps described below. The architecture can include various interfaces including application programming interfaces (APIs). In general, the price tag viewer 400 architecture operates to take a current view of a scene in an Augmented reality (AR), virtual reality (VR), or mixed reality (MR), and determines how to position and orientate a virtual price tag on a product in the scene. Additionally, the architecture includes methods to determine a template for the virtual price tag. The processes describe below are continuously run as a user navigates a scene. For example, the processes continue to run and update the virtual price tag as a user navigates either in a physical scene with AR or a virtual scene in VR. This allows the virtual price tag to be placed and presented in an optimal manner as the user's position relative to the product changes or in response to an occluding object and/or change in lighting.

FIG. 15 illustrates a block diagram of an example price tag viewer 400 architecture. In the example shown, the architecture includes a dynamic variables engine 402, a scene checker 404, a preference engine 406, a price tag template selector 408, an attachment type selector 410, and a price tag applicator 412.

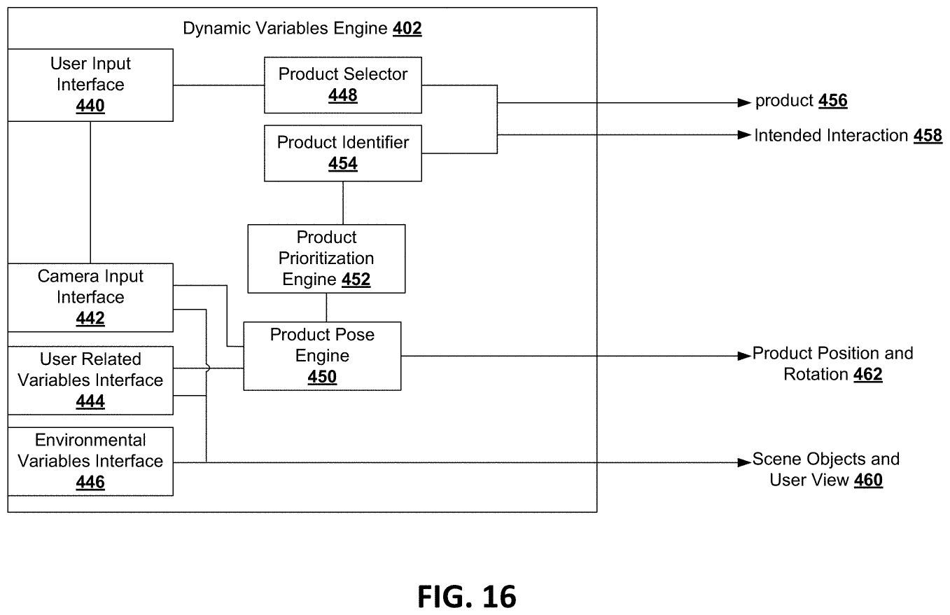

In some embodiments, the price tag viewer 400 first determines whether the user is viewing a virtual scene in VR or a physical scene in AR. Next, the dynamic variables are received using the dynamic variables engine 402. In VR scenes, the dynamic variables include selections (e.g., user selections of furnishings) and/or objects downloaded and included as part of a virtual scene. In AR scenes, the dynamic variables include an image or stream of images from a camera. Inputs received by the dynamic variables engine 402, in either AR, VR, or MR, can further include environmental variables and user related variables. In some embodiments, these inputs are processed by the dynamic variables engine 402 such that outputs can be accessed by the scene checker 404. In some embodiments, the dynamic variables include further variables received as part of an augmented reality application. For example, voice inputs, gestures, eye tracking inputs, data from other AR sensors (e.g., LIDAR sensor, sonar, etc.). In other examples, the inputs are received as part of a virtual reality system, including information about the virtual scene, virtual objects in the scene, a current view, and user inputs. In typical embodiments, the dynamic variables are continuously updated based on receiving updated inputs. For example, image data from a camera is continually received from the user computing device and processed. A block diagram of an example dynamic variables engine 402 is illustrated and described in reference to FIG. 16.

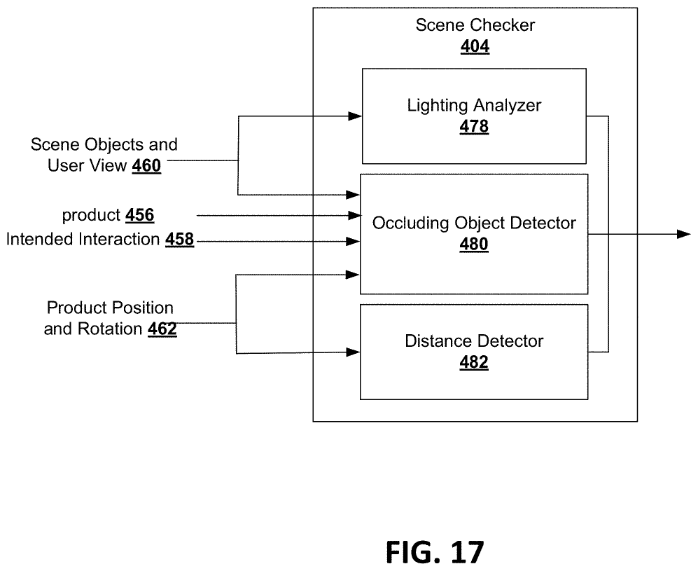

The scene checker 404 analyzes the scene in which the product or group of products are presented. In some embodiments, the scene checker 404 receives a plurality of variables from the dynamic variables engine 402. These variables can relate to either a virtual scene (VR examples) or a physical scene (for example, as captured from a camera in AR examples). In some embodiments, the scene checker 404 receives an identified or selected product from the dynamic variables engine 402 and processes the scene to determine the lighting conditions of the of the scene, objects occluding the view of the product, and a distance (either a physical distance or a virtual distance represented in the virtual scene) between the product the current view of the scene. For example, the lighting analysis is used to determine which surfaces of a product have neutral lighting (e.g., not in shadow and not in direct sunlight) and/or removes and which surfaces are visible from a point of view taking into account occluding objects. Additionally, the distance analysis can be used to determine how the visible surfaces appear to a user. In some embodiments, the distance to the product is used to determine a virtual price tag type by the price tag template selector 408. A block diagram of an example scene checker 404 is illustrated and described in reference to FIG. 17.

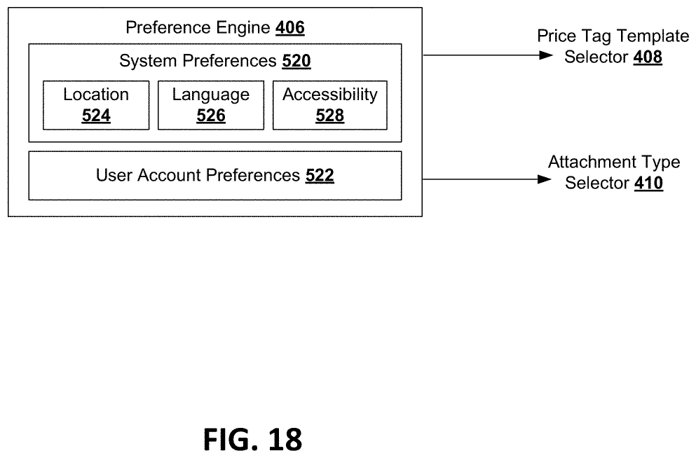

In some embodiments, the preference engine 406 interfaces with system preferences of a user device (e.g., the user computing device 106 illustrated in FIG. 1) and/or user account preferences. These preferences can be used to determine a location of the user computing device, a language preferred by a user, and accessibility settings (e.g., text size, contrast, dark mode, audio cues, etc.). These settings can be used to determine a price tag template at the price tag template selector 408 and the attachment type at the attachment type selector 410. A block diagram of an example preference engine 406 is illustrated and described in reference to FIG. 18.

The price tag template selector 408 determines a template for a virtual price tag. The price tag template selector 408 receives scene information from the scene checker 404 to determine a price tag template for a selected product. For example, a retailer may have multiple price tag templates in different sizes and formats based on the product. For example, a small sticker may be added to a cup or a huge banner which can be read from far away from a large object (e.g., a car). In some embodiments, the virtual price tag placed on a product generally matches the selection which would be expected for a physical price tag on a physical product. In some embodiments, the template of the virtual price tag is adjusted based on the distance from the user's view of the product. In some of these examples, the price tag templates include templates designed to be read at different ranges of distances. For example, one template is presented when the users view of the product is within one meter, another when the product is between one meter and five meters away, a third when a product is five to ten meters away, and a fourth when the product is over ten meters away. In some examples, the price tag templates are filtered based at least in part on the current distance the user's view is from the product. Again in these examples, the virtual price tag template may change as the user moves closer to or further from the product. In some embodiments, the price tag type is based on the lighting. For example, the color of the virtual price tag may be selected to complement the lighting at the location where the virtual price tag is placed.

In some embodiments, price tag templates include templates for different types of price tags. For example, a default template may include price details and product information, a combination virtual price tag may include price details and product information for a set of products (e.g., each product may have an individual price and a different price is used when buying the product as part of a set). Some templates include additional information such as, function information, buying instructions, and picking lists (where the product can be found in a warehouse). Different virtual price tag templates can be used for different promotional goals. For example, a template may be selected to bring attention to a low price, a key message, and/or a reduced price sign.

The attachment type selector 410 determines how the virtual price tag is attached to the product. In some embodiments, the attachment type selector 410 stores a plurality of rules for attaching the virtual price tag to the product. In some embodiments, these rules are based on policies for placing price tag on physical products in retail stores. In some embodiments, the rules for determining how to attach the virtual price tag includes a default rule. For example, a default rule could include hanging the virtual price tag directly to the product using a faster (e.g., string or a self-adhesive loop). Other rules can include: (1) using a self-adhesive price tag when a flat surface is identified; (2) using a fastener when specific type of textile is detected; (3) identifying a seam to fasten the price tag; (4) placing the price tag at a specific location on types of products. Example of product specific rules include attaching a virtual self-adhesive price tag on the lower left corner when the product is a rug or other type of flooring, attaching a virtual price tag with a string on the left armrest when the product is a sofa, hanging a virtual price tag at eyelevel for a customer when the product is a ceiling lighting product presented on a ceiling. Additionally, rules for determining how to attach the virtual price tag can be based on the type of price tag selected by the price tag template selector 408.

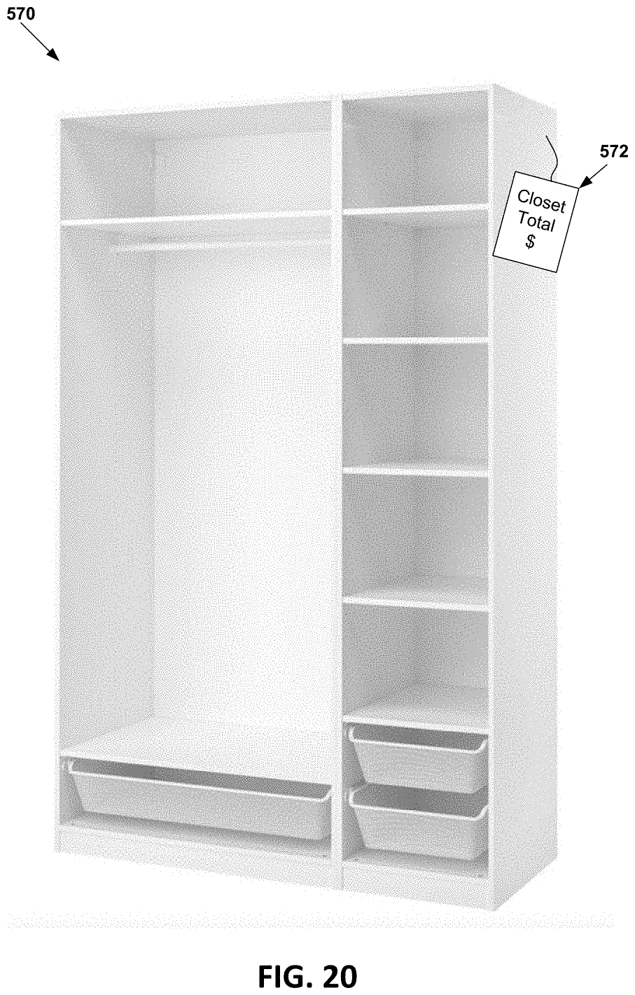

The price tag applicator 412 determines a position and a rotation for the virtual price tag. In some embodiments, a product includes a list of predetermined points where a virtual price tag can be positioned and the price tag applicator selects one of these points to place the price tag by analyzing the outputs from the scene checker 404, price tag template selector 408, and the attachment type selector 410. In some embodiments, the price tag applicator 412 filters the list of predetermined points based on detected features in the scene (e.g., lighting, occluding objects, and distance). In some embodiments, the price tag applicator 412 scores the predetermined points and places the virtual price tag at the highest scoring point. In addition to selecting a point to place the virtual price tag selector the price tag applicator 412 determines a rotation of the virtual price tag such that the virtual price tag is at a realistic orientation. In some embodiments using an AR system, the price tag applicator 412 applies augmented lighting to the virtual price tag to improve the visibility of the price tag. A block diagram of an example price tag applicator 412 is illustrated and described in reference to FIG. 20.

FIG. 16 illustrates a block diagram of an example dynamic variables engine 402. The dynamic variables engine 402 shown is an example of the dynamic variables engine 402 illustrated and described in reference to FIG. 15. In the example shown, the dynamic variables engine 402 includes a user input interface 440, camera input interface 442, a user related variables interface 444, an environmental variables interface 446, a product selector 448, a product pose engine 450, a product prioritization engine 452, and a product identifier 454. Examples of outputs from the dynamic variables engine 402 include a product 456, an intended interaction 458, a product position and rotation 462, and a scene objects and user view 460. Each of the product 456, the intended interaction 458, the product position and rotation 462, and the scene objects and user view 460 can include a data structure defining the corresponding features and variables.

In some embodiments, the dynamic variables engine 402 is executed on a user computing device. In some of these examples, the product identifier 454, the product pose engine 450, product prioritization engine 452, product identifier 454 interact with an e-commerce server to perform some of the operations described herein.

Examples of input interfaces which can be included as part of dynamic variables engine 402 include a user input interface 440, a camera input interface 442, a user related variables interface 444, and environmental variables interface 446.

The user input interface 440 receives inputs from a user, including inputs typically used in AR and VR applications. For example, inputs can be received from a touch screen, hand tracker, eye tracker, detected voice commands, etc. Example user inputs in virtual reality embodiments, include a user selections of a virtual scene which may include one or more products, selections of a product or multiple product or, in some AR embodiments, selections of a product or multiple products to be displayed in augmented reality.

The product selector 448 operates to receives product and/or scene selections via the user input interface 440 and outputs the selected product 456. In some embodiments, a database stores a plurality of product entries including production information. Examples of product information include a product name, a price, and dimensions. The product selector 448 retrieves the selected product information from the database and outputs this information as part of the product 456. In some embodiments, the product selector retrieves an intended interaction for the selected product. For example, if the product is a chair, then the intended interaction 458 is that a person may sit on the seat of the chair. The intended interaction can be stored as a rule associated with the product. The intended interaction can be provided to the price tag applicator 412 to eliminate attaching the virtual price tag on at location where a user may block the location on the product where the virtual price tag is attached when interacting with the product. For example, the intended interaction 458 can be used to eliminate positioning the virtual price tag on the seat of the chair because this area is likely to be covered when a user interacts with the product.

In some embodiments, the product 456 is identified with the product identifier 454. In these embodiments, the camera input interface 442 receives image data for an image or stream of images. The image data is processed by the product pose engine 450 and the product prioritization engine before a product (or in some examples, products) is identified by the product identifier 454. Each identified product is output from the dynamic variables engine 402 as the product 456.

The camera input interface 442 interfaces with a camera on a user computing device. In some embodiments, the camera input interface 442 receives image data which is processed to detect features in a scene. The camera input interface 442 may work with other sensor interfaces (not shown) to detect features in a physical scene. In some embodiments, the camera input interface 442 receives image data from a camera array. Examples of cameras and camera configurations are further described above. Some VR embodiments may not include a camera input interface.

The product pose Engine 450 detects potential products in the image data and calculates a current position and orientation of identified potential products. In some embodiments, the image data is processed using a computer vision algorithm which identifies objects in a scene. The product pose engine 450 may identify which objects may be products based on features detected in the image data. For example, if the AR viewer is part of a furnishing retailer, the product pose engine 450 may operate to eliminate products which are likely not included in the catalog of furnishings. In some embodiments, the product pose engine 450 may filter detected objects against a set of rules. After the potential products are identified the position and rotation of each potential product is calculated by processing the image data. This data is provided to the product prioritization engine 452. After a product is identified by the product identifier the product pose engine 450 outputs the product position and rotation 462 for the identified product. The product position and rotation 462 is based on the products position in the scene and orientation to the user's view.

The product prioritization engine 452 prioritizes the detected potential products. The prioritization can be based on which of the potential products are in focus in the image. The prioritization can further be based on the position of the potential product in the scene and the orientation. For example, the product position and orientation information calculated by the product pose engine 450 can be analyzed to prioritize products in the center of the scene which are oriented towards the user's view. The prioritization of the potential products is provided to the product identifier 454.

In AR scenes, the product identifier 454 identifies a single product or a group of products visible in the AR scene. The detected potential products are analyzed by comparing the image data of the potential products with models or sample images of the product. In these example, the models or sample images are stored in a database at or connected with the e-commerce server. In some embodiments, a computer vision algorithm is used to identify features the detected potential products which are compiled to identify the product. In some embodiments, the potential product with the highest priority is analyzed. In some embodiments, the products with the top “N” prioritization scores are analyzed (e.g., top three products). In some example, every detected product is analyzed.

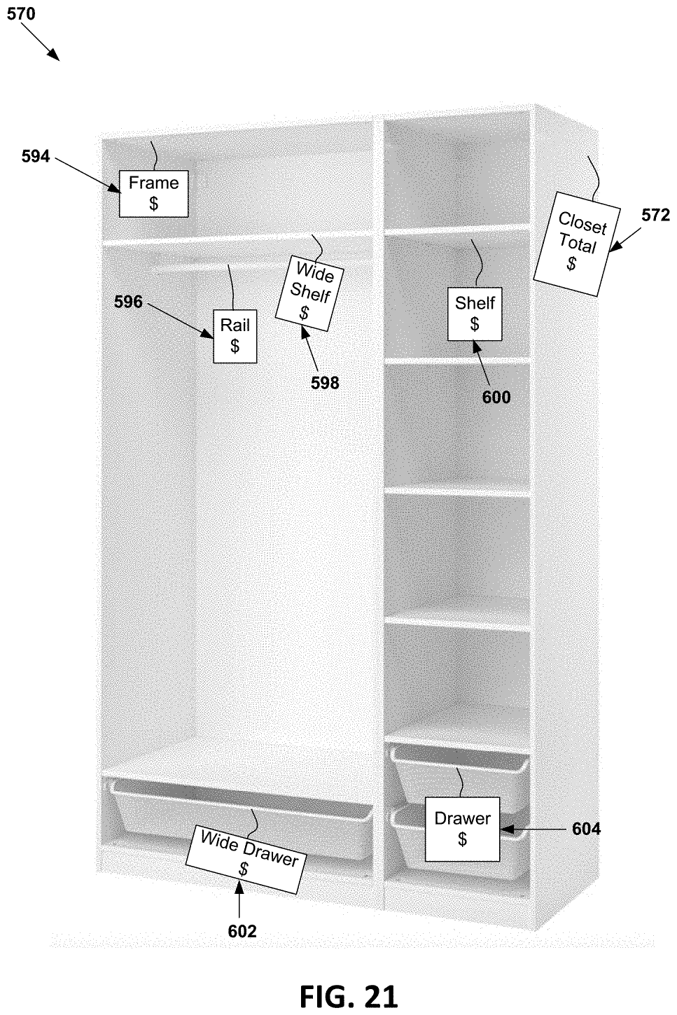

The product 456 can include a single identified product or multiple products. In some embodiments, a group of products is sold as part of an assembly or as part of a set. For example, a product may be a closet assembly which includes different variants of sub-products (e.g., frames, doors, handles, shelves, rails etc.). In some embodiments, a user can select each sub-product to create a customized product. In some embodiments, a user can select a product with a predetermined selection and arrangement of sub-products from one of a plurality of different arrangements. In some embodiments, a single virtual price tag is generated for the product including the entire selected arrangement of sub-products. For example, as shown in FIG. 20. In some embodiments, additional price tags are selected and placed on each type of sub-product. For example as shown in FIG. 21.

In some embodiments, the dynamic variables engine 402 further outputs an intended interaction 458 for a given product. The intended interaction can further provide restrictions on where to place the virtual price tag and how to attach the virtual price tag. For example, if the product is a chair the intended interaction may indicate that a user is likely to sit on a chair, and therefore restrict the virtual price tag from being placed where a user would sit. In another example, a frying pan product may include an intended interaction of a user grabbing the handle of the frying pan, and therefore the intended interaction 458 output indicates that the virtual price tag should not be attached to the handle. In some embodiments, each product with an intended interaction is associated with a set of rules for positioning and selecting a virtual price tag. In other embodiments, the intended interaction 458 is used to score different points based on the likelihood that the interaction would interfere with the presentation of the virtual price tag. In some embodiments, the intended interactions are learned by how users interact with a product over time. For example, if certain areas are frequently occluded the system can determine that the product is used in a certain way which tends to lead to those surfaces being occluded.

The user related variables interface 444 receives inputs related to the user. In some embodiments, the user related variables interface 444 interfaces with an AR, VR, or mixed reality (MR) application. For example, the user related variables interface 44 may receive information of where a user is positioned in a virtual scene from a virtual reality application. In another example, the user related variables may receive eye tracking information from either an AR, VR, or MR application.

The environmental variables interface 446 receives inputs related to the environment of the scene. In some embodiments, the environmental variables interface 446 interfaces with an AR, VR or MR application. For example, the environmental variables may receive environmental information about a virtual scene, (e.g., lighting, size of scene, distance between objects, etc.). In AR embodiments, the environmental variables may include environmental information received from an AR application. For example, the environmental variables can be detected by processing an image or a stream of images of the physical scene.

The dynamic variables engine 402 outputs scene object and user view 460 based on the inputs received from the camera input interface 442, the user related variables interface 444, and the environmental related variables. The output information includes detected objects and current view from the user's perspective.

FIG. 17 illustrates a block diagram of an example scene checker 404. In the example shown, the scene checker 404 includes a lighting analyzer 478, an occluding object detector 480, and distance detector 482. Inputs for the scene checker include a product 456, scene objects and user view 460, and product position and rotation 462. The output from the occluding object detector 480 and the distance detector 482 is provided to the price tag template selector 408, the attachment type selector 410, and the price tag applicator 412 (as shown in FIG. 15).

In typical embodiments, the scene checker 404 processes the outputs from the dynamic variables engine to identify features in the scene to select a price tag template at the price tag template selector 408, select an attachment type at the attachment type selector 410, and to place the virtual price tag with the price tag applicator 412.

In the example shown, the inputs received at the scene checker 404 include scene objects and user view 460, a product 456, intended interaction 458, and product position and rotation 462, each of which is described in reference to FIG. 16.

The lighting analyzer 478 detects the lighting conditions on the product. In some embodiments, the lighting analyzer receives scene objects and user view 460. In some examples, the lighting analyzer processes the scene objects and user view 460 to determine the lighting conditions in the scene. The price tag applicator 412 uses the calculated lighting conditions to place the virtual price tag at a location with neutral lighting. For example, the lighting analyzer 478 can determine which areas of the product are in a neutral lighting condition and this information is used by other processes to determine a template for the virtual price tag, a position, and orientation for the virtual price tag. In typical embodiments, the lighting analyzer 478 outputs a data structure defining the lighting environment of the scene and/or of the product, including information defining areas of the product which are in neutral lighting.

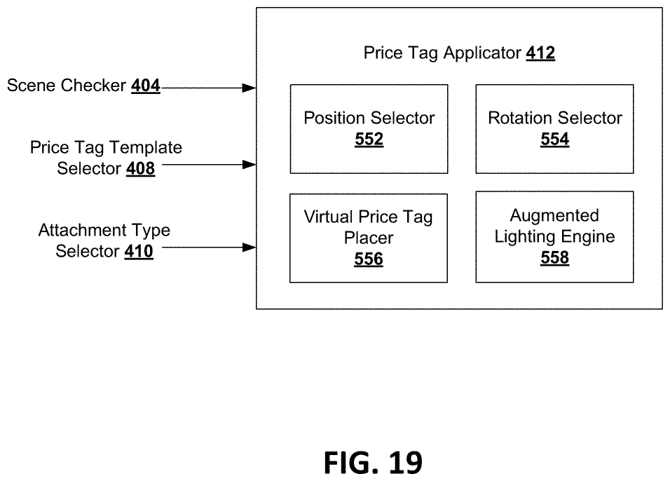

The occluding object detector 480 determines what surfaces on a product is occluded by an object. Inputs received by the occluding object detector include scene objects and user view 460, product 456, intended interaction 458, and product position and rotation 462. In some embodiments, the occluding object detector 480 identifies visible surfaces based on the users view of the scene including any objects between the user's view and the product based on the received the scene objects and user view 460 and the product 456 inputs. In some embodiments, the occluding object detector 480 calculates a percentage of an object is occluded. In some embodiments, the price tag template selector 408 uses the percentage of the object that is occluded to select a template for the virtual price tag. As described in more detail in reference to FIG. 19, in some embodiments, the price tag applicator 412 filters locations to place the virtual price tag to remove occluded locations. Additionally, the occluding object detector 480 also determines which of the visible surfaces are likely to be occluded based on an associated intended interaction 458. For example, if the product is a chair and the occluding object detector detects a seat surface then the occluding object detector 480 will mark the seat as occluded (or likely to be occluded) based on the intended interaction 458 associated with the chair. In typical embodiments, the occluding object detector 480 outputs a data structure defining the non-occluded areas of the product.

The distance detector 482 determines the distance the current view is from the product. In some embodiments, the distance detector 482 calculates a physical distance the user computing device is from the image data of the scene. In some embodiments, the distance is a virtual distance which is calculated based on the position a product is shown in a virtual scene from the current view of the virtual scene. In typical embodiments, the distance detector 482 outputs a calculated distance from the product 456. In some embodiments, the distance calculated by the distance detector 482 is used to select a template for the virtual price tag and/or to determine a size for the virtual price tag.

FIG. 18 illustrates a block diagram of an example preference engine 406. In the example shown, the preference engine 406 includes system preferences 520 and user account preferences 522.

The system preferences 520 include location preferences 524, language preferences 526, and accessibility preferences 528. In some embodiments, the system preferences 520 are stored as part of the user computing device operating system. In other embodiments, the system preferences 520 are stored as part of the price tag viewer application.

The location preferences 524 can be used to select information which is displayed on the virtual price tag. In some embodiments, the currency displayed on the virtual price tag is selected based on the current location of the user computing device. In some embodiments, delivery or checkout options are displayed on the virtual price tag and are based on the current location of the user device. For example, if a user is a display room in a particular store the virtual price tag can include information on what aisle the product is shelved in the particular store by locating a user device's location.

In some embodiments, the language displayed on the virtual price tag is based on the location of the user. In other embodiments, the language preferences 526 are stored as part of the system preferences 520. For example, the user computing device may include an operating system which stores a language preference for the user. This preference can be retrieved and used for determining the language of the text on the virtual price tag.

Accessibility preferences 528 can include text size preferences, dark mode, contrast settings, text reading capabilities, etc. The accessibility preferences 528 are applied to the virtual price tag. For example, the text size of the virtual price tag can be adjusted based on the accessibility preferences, the coloring of the virtual price tag can be adjusted based on contrast settings, and/or audio reading the virtual price tag can automatically be generated if voice assistance is enabled.

In some embodiments, the user account preferences 522 include user preferences and user data. The user account preferences 522 can store information about the current user. For example, user login name and password, user preferred payment methods, delivery address, etc. In some embodiments, a user can login to an account and save a list of products the user is interested in. In some embodiments, the user account preferences 522 may store or be linked with additional user data. For example, the e-commerce system may track items the user has viewed in the past. In some embodiments, this data is used to make product recommendations and promotional recommendations.

In the example of FIG. 15 the preferences are provided to the price tag template selector 408 and the attachment type selector 410. The template of the virtual price tag and the contents displayed can be based, at least in part, on these preferences. Additionally, the attachment type used can be based, at least in part, on these preferences.

FIG. 19 illustrates a block diagram of an example price tag applicator 412. In the example shown, the price tag applicator 412 includes a position selector 552, rotation selector 554, and a virtual price tag placer 556. In the example shown (and as shown in FIG. 15), inputs to the price tag applicator 412 are provide from the scene checker 404, the price tag template selector 408, and the attachment type selector 410.

The position selector 552 determines where to place the virtual price tag. In some embodiments, each product includes an associated list of predetermined points to place the virtual price tag. These points are filtered based on which are visible from the current view based on the users view of the product and any occluding objects (the information of which is received from the scene checker 404). The remaining predetermined points are further filtered based on the lighting conditions. The position selector can select a remaining predetermined point based on a policy (e.g., top right predetermined point). In some embodiments, if no predetermined points are in natural lighting, then the predetermined point with the best lighting is selected.

In some embodiments, if no predetermined points are available the virtual price tag placer 556 waits until the user's view changes or an occluding object moves to place the virtual price tag. In some embodiments, a visible surface is selected to place the virtual price tag.

In some embodiments, the position selector 552 scores each of the predetermined points based the user view, the lighting conditions, occluding objects, and the distance from the product. In these embodiments, the virtual price tag is positioned at the highest scoring predetermined point.

The rotation selector 554 adjusts the placement of the virtual price tag such that the orientation of the virtual price tag is realistic. For example, based on the angle of the product and the angle of the user's view of the product, the virtual price tag is rotated to match the angle of the surface it is attached to. In some embodiments, this rotation is predetermined for each product based on the different surfaces. In other examples, it is calculated by analyzing the image or stream of images of the product. In some embodiments, the virtual price tag is rotated and oriented to improve the visibility for the user.

The virtual price tag placer 556 places the virtual price tag in AR, VR, or MR. For example, the virtual price tag placer 556 displays the virtual price tag overlayed a live stream of images of the product to show the virtual price tag in AR. In other examples, the virtual price tag placer 556 places the virtual price tag on a virtual product in either AR, VR, or MR.

In some embodiments, the price tag applicator 412 includes an augmented lighting engine 558. The augmented lighting engine is used in augmented reality examples. In some embodiments, the augmented lighting engine 558 operates to present a price tag with virtual lighting in order to improve the readability of the virtual price tag. In some embodiments, the augmented lighting engine 558 receives information about the placement of the virtual price including the lighting conditions around where the virtual price tag is attached. The lighting conditions around where the virtual price tag is placed are analyzed by the augmented lighting engine 558 to determine a current lighting level. In other embodiments, the lighting is analyzed at the scene checker 404 with the lighting analyzer 478. If the current lighting level is below a predetermined threshold the augmented lighting engine instructs the AR viewer to display augmented lighting to the virtual price tag.

FIGS. 20 and 21 illustrates an example display of a virtual price tag application including a product 570 comprising an assembly of sub-products. Referring first to FIG. 20, the product 570 comprises various sub-products with a combination virtual price tag 572. FIG. 21 illustrates the product 570 with a combination virtual price tag 572, and individual virtual price tags 594 (for the frame), 596 (for the rail), 598 (for the wide shelf), 600 (for the shelf), 602 (for the wide drawer), and 604 (drawer) for each type of sub-product. In some embodiments, a virtual price tag is placed on each sub-product. However, in other embodiments, such as the embodiment illustrated in FIG. 21, only one of identical sub-products include a virtual price tag attached. In some embodiments, a set of rules are used to determine which sub-product of a set of identical sub-products a virtual price tag is placed. For example, a rule may determine to place the virtual price tag on the upper right most sub-product or determine an optimal sub-product based on the lighting, any occluding objects, and the distance the current view is from each of the identical sub-products.

In some embodiments, when a product is identified an assembly of sub-products the virtual price tag viewer analyzes the users view, the lighting conditions, occluding object, and distance from the view for the entire product assembly. The combination price tag is then place based on the features of the entire product assembly in the scene.

In some embodiments, when a user is far away from a product with a group of sub-products only a single virtual price tag is placed for the product assembly. In these embodiments, when a user walks closer to the product virtual price tags are displayed on the various types of sub-products.

In some embodiments, a plurality of products of the same type are detected in a scene. In some of these embodiments, a virtual price tag is only placed on a single product of the plurality of products. Selecting a single product to place a virtual price tag instead of on each of the plurality of products can improve the user's view of the scene by avoiding the placement of repetitive and distracting virtual price tags.

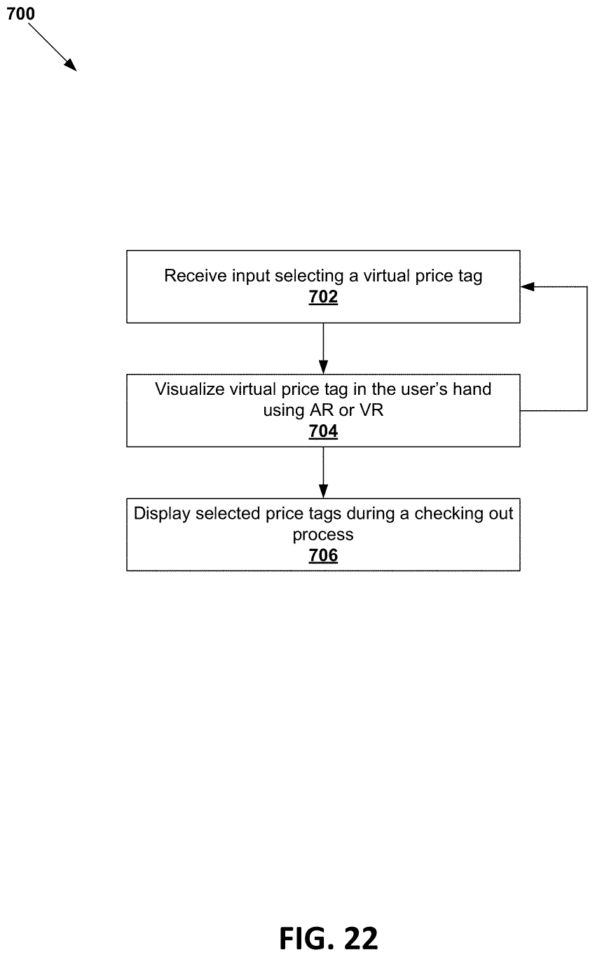

FIG. 22 illustrates an example method 700 for selecting a virtual price tag for a checkout process. In some embodiments, the method 700 is executed as part of the virtual price tag viewer executing on a user computing device. The method 700 includes the operations 702, 704, and 706.

The operation 702 receives an input selecting the virtual price tag. In some embodiments, the user input is a selection on a touch screen or a controller. In other examples, an AR or VR application tracks the user's eye and when a user stares at a price tag for a predetermined period of time to select the virtual price tag.

The operation 704 visualizes the selected virtual price tag in the user's hand. In some embodiments, an animation of pulling the virtual price tag and moving it to appear in the user's hand is displayed in AR or VR. The operations 702 and 704 can be repeated as a user navigates a physical or virtual scene with multiple products. In some embodiments, this allows a user to look at selected price tags with a gesture or by looking at their hands while navigating a scene for additional products of interest.

The operation 706 displays the selected price tags when a user is in a checkout process. For example, a user at physical store may navigate through different display rooms with different products. When the user is ready to checkout the user can view the selected price tags which can include information on what aisle in the store the user can go to pick up the product. In other examples, an interface for adding the products associated to the price tag to a shopping cart and performing an online checkout process can be displayed to the user checking out.

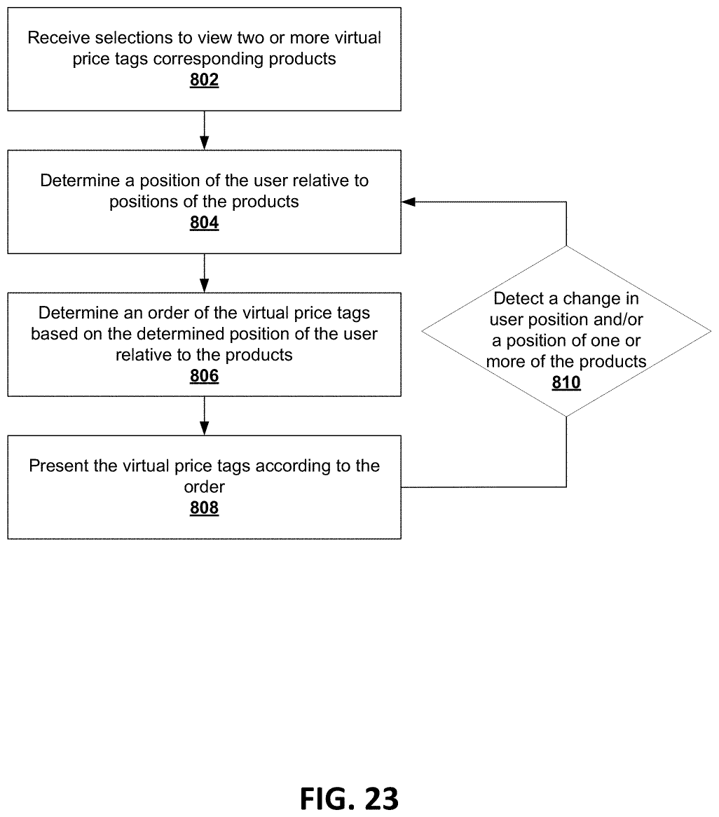

FIG. 23 illustrates an example method 800 for presenting two or more virtual price tags in VR and/or AR. In some embodiments, the method 800 is executed as part of the price tag viewer 114. For example, the price tag viewer embodiments illustrated and described with reference to FIGS. 1, 2, 8, and 9. In some embodiments, the method 800 is built into the virtual price tag viewer architecture 400 illustrated and described in reference to FIGS. 15-19. The method 800 includes the operations 802, 804, 806, 808, and 810.

The operation 802 receives selections to view two or more virtual price tags corresponding to products. In some embodiments, a user may select two or more virtual price tags attached to corresponding virtual products. In some examples, after a virtual price tag is selected the position of the price tag will move to appear as if it is in the users hands (e.g., in either AR, MR, or VR), where when there are multiple price tags selected each price tag will appear adjacent to the other ones allowing the user to view each selected price tag simultaneously.

The operation 804 determines a position of the user relative to positions of the products. In some VR embodiments, the user's position is determined with a VR engine which renders the products relative to the position and view of the user. In AR and/or MR embodiments, an AR engine determines a relative position of products based on images received from a camera on the user's device.

The operation 806 determines an order of the virtual price tags based on the determined positions of the user relative to the products. In some embodiments, the virtual price tags are ordered according to match the order of the products as viewed by the user (e.g., from left to right based on the relatively position of each product). In some embodiments, an ordering of virtual price tags is based at least in part on a distance from the user. In some embodiments, the order of the virtual price tags are determined based on the angle of the associated product from the view of the user. For example, the user's direct view being 90 degrees with directly left of the user being 0 degrees (and 360 degrees) and directly right of the user being 180 degrees the price tags may be ordered from left to right from the angels closest to 0/360 degrees to the angles closest to 180 degrees. In some embodiments, the virtual price tags are ordered based at least on price of the associated product. For example, from high to low or low to high.

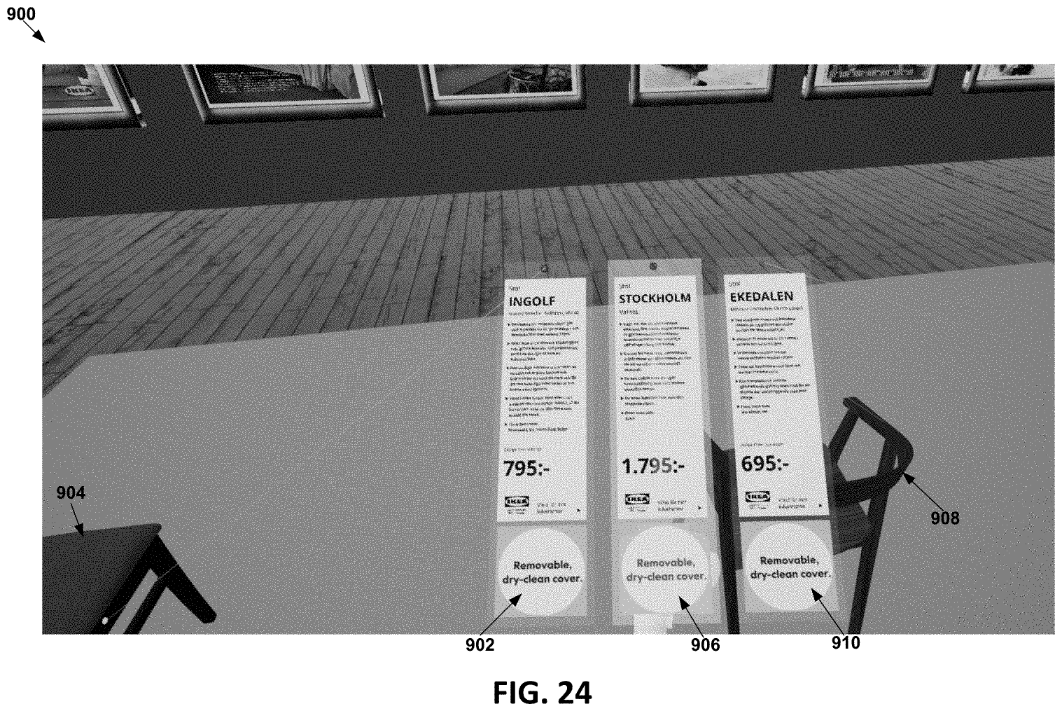

The operation 808 present the virtual price tags according to the order. In some examples, a rendering of a digital string attaching each virtual price tag to an associated product is rendered on a display. In some embodiments, the virtual price tags are rendered in a magnified view to allow the user to view the content on the virtual price tags. An example of presentation of the virtual price tags within a VR application is illustrated and described in reference to FIG. 24. In some embodiments, displaying a magnified view of two or more virtual price tags allows the user to compare details and specifications of various products. In some embodiments, each virtual price tag is associated with a product via a virtual string which connects the virtual price tag to the particular product it is associated with. In some embodiments, the virtual price tags are presented at predefined position, for example, to appear as if the user is holding the virtual price tags in their hands.

The operation 810 detects a change in user position and/or a position of the one or more products and repeats the operations 804, 806, and/or 808 in response to the detection. In some embodiments, the operations 804, 806, and/or 808 repeat periodically, for example, on a per frame basis. The operation 810 allows for the reordering of the price tags based on changes to the relative position of products from the user's view. For example, in real time as either the user's view and/or position changes and/or the movement of one of the products.

FIG. 24 illustrates an example virtual reality interface 900 with multiple virtual price tags selected. The example shown includes a first virtual price tag 902 for a first virtual product 904, a second virtual price tag 906 for a second virtual product 908, and a third virtual price tag 910 attached to a product which is out of the current view of the user. The virtual price tags (902, 906, 910) are ordered based on the relative view of the products (904, 908, and a third product out of view). The example shown includes three virtual prices tags, however, embodiments can include any number of virtual price tags presented to the user.

In some embodiments, when the number of selected virtual price tags exceeds a threshold (e.g., exceeding the number of virtual price tags which can usefully be presented to a user based on the size of the display) a subset of the selected virtual price tags are presented to a user. For example, if a user has selected ten virtual price tags but the display can only present five virtual price tags at a size which allows a user to view the details, then the five price tags, which are associated with the five products that are closest to the user, are presented to the user. The user is then able to view other virtual price tags by changing location (e.g., changing which of the products which are closest to the location of the user). In some embodiments, the virtual price tags that are associated with products that are not within the current view of the user are filtered and not displayed to the user. The ordering of the virtual price tags may update as either the user moves in the environment or based on the movements of the products. For example if the position of the first product 904 is switched with the second product 906 then the order of the virtual price tags will update accordingly with the second virtual price tag 906 presented on the left side and the first virtual price tag 902 being presented between the second virtual price tag 906 and the third virtual price tag 910.

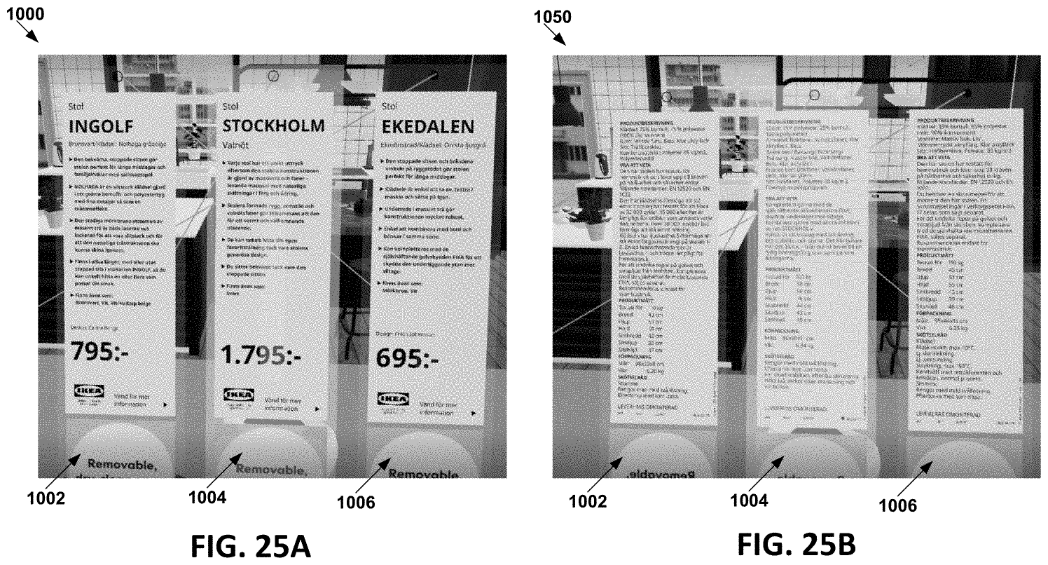

FIG. 25A illustrates an example virtual reality interface 1000 with multiple virtual price tags selected. The example shown includes a front view of a first virtual price tag 1002, a second virtual price tag 1004, and a third virtual price tag 1006.

FIG. 25B illustrates an example virtual reality interface 1050 with multiple virtual price tags selected. The example shown includes a back view of a first virtual price tag 1002, a second virtual price tag 1004, and a third virtual price tag 1006.

Referring to FIGS. 25A and 25B in some embodiments, a user can provide a selection to flip between the front view and the back view of the virtual price tags 1002, 1004, and 1006. In some embodiments, a single input rotates all of the virtual price tags 1002, 1004, and 1006. In some embodiments, a user may select to rotate only a selected virtual price tag of the virtual price tags 1002, 1004, and 1006. Although the example shown includes three virtual price tags, similar operations are performed with any number of presented virtual price tags.

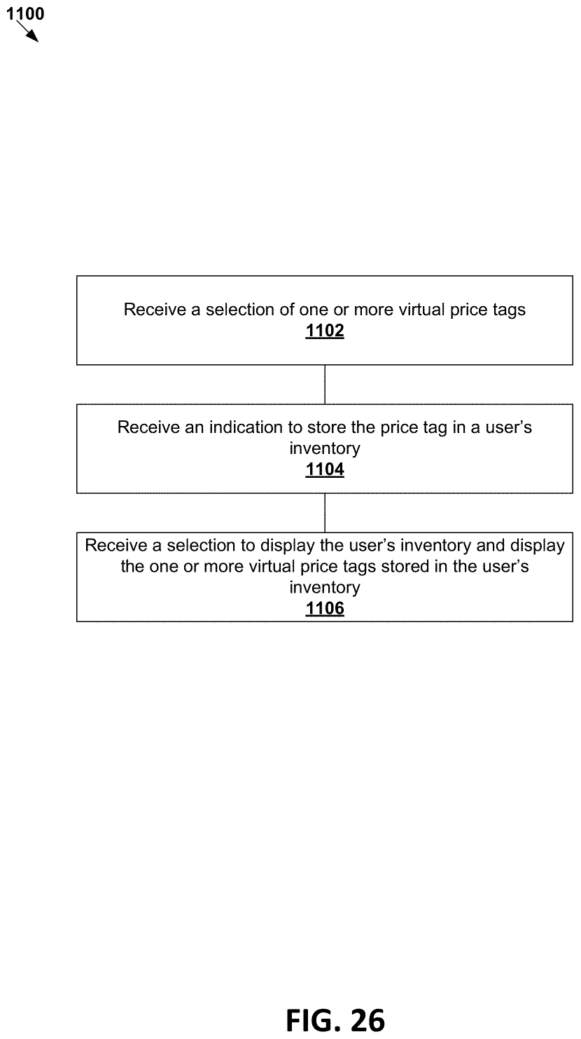

FIG. 26 illustrates an example method 1100 for storing one or more virtual price tags in a user's inventory. In some embodiments, the method 1100 is executed as part of the price tag viewer 114. For example, the price tag viewer embodiments illustrated and described in reference to FIGS. 2, 8, and 9. The method 1100 includes the operations 1102, 1104, and 1106.

The operation 1102 receives a selection of one or more virtual price tags. In some embodiments, a user selects a virtual price tag to view a magnified view of the virtual price tag. Examples for selecting a virtual price tag in AR, MR, and/or VR embodiments are illustrated and described herein.

The operation 1104 receives an indication to store the price tag in a user's inventory. In some embodiments, a virtual price tag is entered into the user's inventory when a user navigates away from the product associated with the virtual price tag without deselecting the virtual price tag. In some embodiments, the indication to store the price tag in a user's inventory is a user input. For example, a selection or a specified gesture.

The operation 1106 receives a selection to display the user's inventory and display the one or more virtual price tags stored in the user's inventory. In some embodiments, when the user's inventory includes two or more virtual price tags, then the virtual price tags are ordered and presented according to the order. An example method for ordering virtual price tags based on a position of the user relative to the position of the products is illustrated and described in reference to FIG. 23. In some embodiments, the virtual price tags displayed from a user's inventory are ordered based on the order the virtual price tags were added to the user's inventory.

In some embodiments, the price tags displayed from the user's inventory include additional information and/or options as compared to when the virtual price tag is initially selected and displayed attached to the virtual product. For example, an image of the product may be displayed within the virtual price tag, additional information about the product, or an option to transport the user to the location of the product.

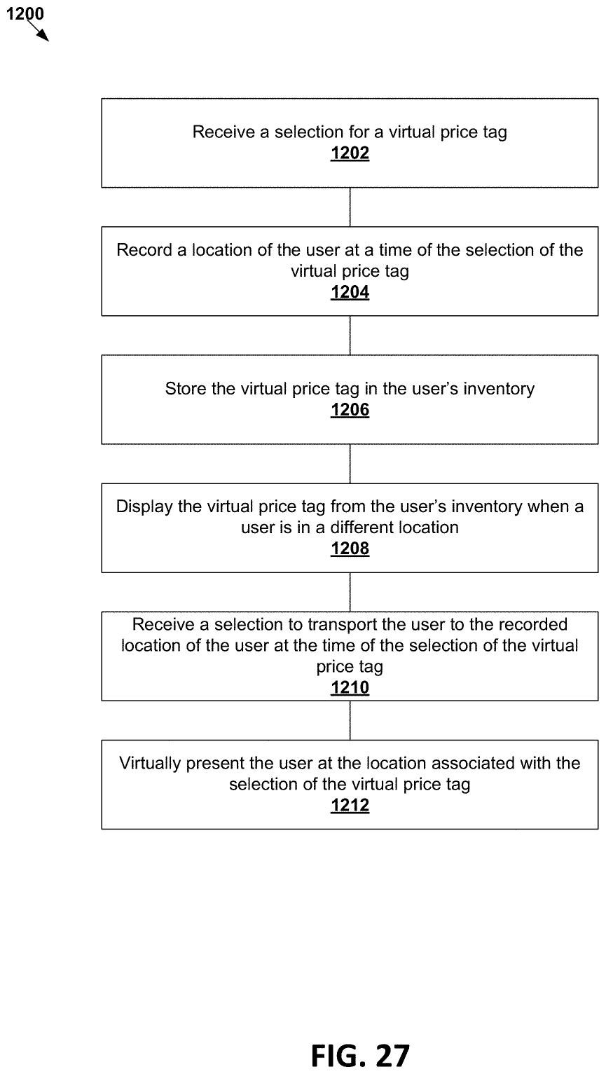

FIG. 27 illustrates an example method 1200 for transporting a user to a virtual location associated with the selection of a virtual price tag. In some embodiments, the method 1200 is executed as part of the price tag viewer 114. For example, the price tag viewer embodiments illustrated and described in reference to FIGS. 2, 8, and 9. The method 1200 includes the operations 1202, 1204, 1206, 1208, 1210, and 1212.

The operation 1202 receives a selection for a virtual price tag. In some embodiments, a user provides an input to select a virtual price tag. Examples for selecting a virtual price tag in AR, MR, and/or VR embodiments are illustrated and described herein.

The operation 1204 determines a location of the user at a time of the selection of the virtual price tag. In VR embodiments, a user location is determined with the VR engine based on the location of the user and view of the user in the virtual environment. In some AR embodiments, an image captured at the time the user selects the virtual price tag in the AR application is stored and associated with the virtual price tag at the operation 1206. In other AR embodiments, a location of the user in the physical environment is determined, where the location is associated with a corresponding location in a virtual environment. For example, where the virtual environment is a digital twin of the physical environment.

The operation 1206 stores the virtual price tag in the user's inventory. The virtual price tag is stored in the user's inventory with the location determined at the operation 1204.

The operation 1208 displays the virtual price tag from the user's inventory when a user is in a different location. In some embodiments, a user input, such as a selection or a gesture, is received to select an option to display the user's inventory. In some embodiments, the one or more virtual price tags in the user's inventory are displayed to the user.

The operation 1210 receives a selection to transport the user to the recorded location of the user at the time of the selection of the virtual price tag. In some embodiments, the selection is provided by an input selection or a gesture (e.g., hand gesture). The selection to transport the user to the recorded location so a user can review the product prior to checking out from either an online or physical store.

The operation 1212 virtually presents the user at the location associated with the selection of the virtual price tag. In virtual reality embodiments, a user is virtually transported in the virtual reality environment to the location where the user initially selected the virtual price tag. In some AR embodiments, a photo, screen, and/or video is captured when the user initially selects a virtual price tag and the captured photo, screen, and/or video is presented in response to the user selecting the selection to transport the user to the recorded location. In some embodiments, the user initially selects the virtual price tag in an AR context and the user is transported to a virtual reality environment at a location corresponding to the physical location in the physical environment (e.g., where the virtual reality environment is a digital twin the physical environment). In some embodiments, a virtual price tag is stored with a permanent location of the virtual product in the environment.

Aspects of the present disclosure may also be described by the embodiments that follow. The features or combination of features disclosed in the following can also be included with any of the other embodiments disclosed herein.

Embodiment 1 is an AR application showing a mixed reality scene from a perspective of a user running the AR application, the AR application configured to: (A) Identify objects in the scene; (B) for a specific object, identify surfaces of the object that is visible for the user, and visualize a virtual price tag having a position on one of the identified visible surfaces such that it looks attached to the surface of the object in a realistic way; and (C) wherein upon the user changing position in the scene, step (B) is performed again. For example, the virtual price tag is attached to a surface with the price tags position recalculated when the user changes views.

Embodiment 2 is the AR application of embodiment 1, wherein the specific objects are real word objects existing in the scene and/or virtual objects placed in the scene.

Embodiment 3 is the AR application of any of embodiments 1-2, wherein the price tag is visualized as being attached to the surface of the object by a string.

Embodiment 4 is the AR application of embodiment 3, wherein when the price tag is visualized on a new position on the object, the price tag is visualized with a dangling motion from the string.

Embodiment 5 is the AR application of any of embodiments 3-4 wherein the user input a command to look closer on the price tag, wherein the price tag is visualized near the user with the string still attached to the identified surface.

Embodiment 6 is the AR application of embodiment 5, wherein the user input a command to look closer on a price tag of a further object of the scene, where the price tag of the further object in the scene is visualized near the price tag of embodiment 5.

Embodiment 7 is the AR application of embodiment 5, wherein the user input a command to stop looking closer at the price tag, wherein the price tag is visualized as being snapped back to the object by the string.

Embodiment 8 is the AR application of any of embodiments 1-7, wherein the virtual price tag is visualized considering light conditions at the position in the scene where it is placed.

Embodiment 9 is the AR application of any of embodiments 1-8, wherein the user can with a command store/buy the product in a list/shopping cart/note (movement of the hand, voice command, swipe on the price tag, click a button on the price tag, etc.).

Embodiment 10 is the AR application of any of embodiments 1-9, wherein information on the price tag is receive from an externa server as a response to transmitting product identifying data to the external server.

Embodiment 11 is the AR application of embodiment 10, wherein upon the specific object being a real word object, the identifying data is extracted from pixel data (3D data or metadata) of the object in a video stream depicting the scene. In some examples, a visual search algorithm is used. In some examples, metadata of an image is used to identify the object (e.g., location or image description). In some examples, 3D data is used to identify the object. For example, time of flight depth info, sound generated by a microphone with an echo picked up by a microphone, camera array depth information. A combination of visual search, metadata and 3D data is used to identify the object. In some embodiments, the methods used to collect the 3D data is also used to extract the 3D position of the object in the scene.

Embodiment 12 is the AR application of embodiment 10, wherein upon the specific object being a virtual object, wherein the data representing the virtual object comprises the identifying data. For example, metadata of the image or the product ID number associated with the virtual object.

Embodiment 13 is the AR application of any of embodiments 1-12, wherein the specific object being a real word object, wherein the identifying of surfaces visible to the user comprises applying an object segmentation algorithm on a video stream depicting the scene, to identify the specific object.

Embodiment 14 is the AR application of any of embodiments 1-13, wherein the specific object being a virtual object, wherein the identifying of surfaces visible to the user comprises: (1) determining a volume in 3D space for each identified object; (2) identify a position in 3D space of the user running the AR application; (3) using the 3D positions of the identified objects and the position of the user to identify surfaces of the virtual object that is visible for the user. For example, with a virtual object an algorithm determines how much of the virtual object is visible to the user and where to place the price tag on the visible surface.

Embodiment 15, is a method for presenting virtual price tags in either AR, MR, or VR, the method comprising: receiving selections to view two or more virtual price tags corresponding to two or more products, determining a position of a user relative to positions of the two or more products, determining an order of the virtual price tags based on the determined position of the user relative to the products, and presenting a visualization of the two or more virtual price tags adjacent to each other according to the order of the virtual price tags.

Embodiment 16 is the method of embodiment 15, wherein a single selection rotates the two or more virtual price tags between a front view and a back view.

Embodiment 17 is the method of any of embodiments 15-16, wherein the two or more virtual price tags are ordered and displayed from left to right based on the position of the user relative to the positions of the two or more products.

Embodiment 18 is the method of any of embodiments 15-17, wherein each of the two or more virtual price tags are rendered with a virtual string attaching each virtual price tag with the corresponding product, wherein the ordering prevents the strings from crossing.

Embodiment 19 is a method for storing a virtual price tag in a user's inventory, the method comprising selecting a virtual price tag for a product, displaying a first magnified view of the virtual price tag, receiving an indication to store the virtual price tag in a user's inventory, receiving an input selecting an option to display the user's inventory, and displaying a second magnified view of the virtual price tag with additional information about the product.

Embodiment 20 is the method of embodiment 19, wherein the additional information includes an image of the product.

Embodiment 21 is a method for virtually transporting a user to a location to view a product associated with a virtual price tag, the method comprising receiving a selection for a virtual price tag, recording a location of the user at a time of the selection, storing the virtual price tag and the recorded location in an inventory associated with the user, receiving an input selecting an option to display the inventory of the associated user, displaying the virtual price tag, and receiving a transport selection to virtually transport the user to the recorded location by displaying a virtual view at the recorded location where the virtual price tag was selected.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for presenting virtual price tags, the method comprising:
identifying a product visible in a scene;
retrieving price data for the product;
identifying visible surfaces of the product from a current view of the scene;
determining a predetermined point on one of the visible surfaces based on the current view of the scene; and
generating, on a display of a computing device, a virtual price tag attached to an image of the product at the predetermined point, the virtual price tag displaying the price data for the product.

2. The method of claim 1, the method further comprising:
assessing the scene to determine a lighting condition of the scene;
detecting objects occluding the product from the current view of the scene; and
calculating a distance between the current view and the product,
wherein the predetermined point is further determined based on the lighting conditions of the scene, the objects occluding the product from the current view of the scene, and the distance between the current view and the product.

3. The method of claim 1, the method further comprising:
retrieving an ordered list of predetermined points on the product corresponding to the likelihood that a physical price tag would be attached to each predetermined point; and
wherein determining the predetermined point is further based on the likelihood that the physical price tag would be attached to the predetermined point.

4. The method of claim 1, wherein the method is repeated when the current view is updated to a new view.

5. The method of claim 1, wherein the scene is a virtual reality scene.

6. The method of claim 1, wherein the scene is a physical scene and the method further comprising:
capturing, from a camera on the computing device, one or more images of the physical scene, and generating an augmented reality scene, on the display of the computing device, using the one or more images and the virtual price tag.

7. The method of claim 6, wherein the augmented reality scene incudes a virtual product.

8. The method of claim 1, wherein the virtual price tag is visualized with a virtual string connecting the virtual price tag to the predetermined point on the product.

9. The method of claim 8, wherein when the virtual price tag is first placed at the predetermined point it is visualized with a dangling motion animation from the virtual string.

10. The method of claim 9, wherein the virtual price tag is selectable, and selecting the virtual price tag comprises:
visualizing the virtual price tag to appear magnified on the display of the computing device with the virtual string remaining attached to the visible surface.

11. The method of claim 10, wherein a second virtual price tag corresponding to a second product is selectable and selecting the second virtual price tag includes visualizing the second virtual price tag to appear magnified adjacent to the virtual price tag.

12. The method of claim 10, wherein selecting the magnified virtual price tag comprises:
displaying an animation of the virtual price tag being snapped back to the product by the virtual string.

13. The method of claim 1, wherein the virtual price tag is visualized with light conditions at a position in the scene where it is placed.

14. The method of claim 9, the method further comprising:
receiving inputs to place the product in a shopping cart; and
initiating a checkout process.

15. The method of claim 1, wherein the price data for the product is retrieved from an e-commerce server and the method further comprising:
transmitting product identifying data to the e-commerce server.

16. The method of claim 15, wherein upon the product being a physical product, the identifying data is extracted from pixel data of the physical product in one or more images depicting the scene and the physical product.

17. The method of claim 15, wherein upon the product being a virtual product, the identifying data is data representing the virtual product.

18. The method of claim 1, wherein identifying the visible surfaces further comprises:
applying an object segmentation algorithm on a video stream depicting the scene, to identify the product.

19. The method of claim 18, wherein the product is a virtual product and the identifying visible surfaces further comprises:
determining a 3D location of the identified product;
identifying a 3D location of the computing device; and
utilizing the 3D location of the identified product and the 3D location of the computing device to identify the visible surfaces.

20. The method of claim 1, the method further comprising:
receiving selections to view two or more virtual price tags corresponding to two or more products;
determining a position of a user relative to positions of the two or more products;
determining an order of the two or more virtual price tags based on the determined position of the user relative to the two or more products; and
presenting a visualization of the two or more virtual price tags adjacent to each other according to the order of the two or more virtual price tags.

21. The method of claim 1, the method further comprising:
selecting the virtual price tag for the product;
displaying a first magnified view of the virtual price tag;
receiving an indication to store the virtual price tag in an inventory of an associated user;
receiving an input selecting an option to present the inventory of the associated user on the display; and
displaying a second magnified view of the virtual price tag with additional information about the product.

22. The method of claim 1, the method further comprising:
receiving a selection for the virtual price tag;
recording a location of a user at a time of the selection;
store the virtual price tag and the recorded location in an inventory associated with the user;
receiving an input selecting an option to present the inventory of an associated user on the display;
displaying the virtual price tag; and
receiving a transport selection to virtually transport the user to the recorded location by displaying a virtual view at the recorded location where the virtual price tag was selected.

23. An augmented reality device comprising:
a camera;
a processor; and
a memory storing instructions which, when executed by the processor cause the augmented reality device to:
identify a product in a physical scene;
retrieve price data for the product;
identify visible surfaces on the product from a current view of the physical scene;
determine a predetermined point on one of the visible surfaces based on the current view of the physical scene; and
generate, on a display of the augmented reality device, a virtual price tag attached to an image of the product at the predetermined point, wherein the virtual price tag displays the price data for the product.

24. The augmented reality device of claim 23, wherein the augmented reality device is a smart glasses device.

25. The augmented reality device of claim 23, wherein the instructions further cause the augmented reality device to:
assess the physical scene to determine a lighting condition of the physical scene;
detect objects occluding the product from the current view of the physical scene; and
calculate a distance between the current view and the product,
wherein the predetermined point is further determined based on the lighting conditions of the physical scene, the objects occluding the product from the current view of the physical scene, and the distance between the current view and the product.

26. A virtual reality device comprising:
a processor; and
a memory storing instructions which, when executed by the processor cause the virtual reality device to:
identify at least one product visible in a virtual scene; and
for each product of the at least one product:
retrieve price data for the product;
identify visible surfaces of the product from a current view of the virtual scene;
determine a predetermined point on one of the visible surfaces based on the current view of the virtual scene; and
generate, on a display of the virtual reality device, a virtual price tag attached to an image of the product at the predetermined point, wherein the virtual price tag displays the price data for the product.

27. The virtual reality device of claim 26, wherein the instructions further cause the virtual reality device to operate a furnishing planner application and receive inputs to create the virtual scene including selecting the at least one product.

28. The virtual reality device of claim 26, wherein the instructions further cause the virtual reality device to:
assess a scene to determine a lighting condition of the scene;
detect objects occluding the product from the current view of the scene; and
calculate a distance between the current view and the product,
wherein the predetermined point is further determined based on the lighting conditions of the scene, the objects occluding the product from the current view of the scene, and the distance between the current view and the product.
